(19) United States
(12) Patent Application Publication
(10) Pub. No.: US 2009/0100264 A1
(43) Pub. Date: Apr. 16, 2009

(54) COMMUNICATION DEVICE AND COMMUNICATION SYSTEM

(76) Inventors: Yuichi Futa, Osaka (JP); Motoji Ohmori, Osaka (JP); Shingo Hasegawa, Miyagi (JP); Shuji Isobe, Miyagi (JP); Hiroki Shizuya, Miyagi (JP)

Correspondence Address: WENDEROTH, LIND & PONACK L.L.P., 2033 K. STREET, NW, SUITE 800, WASHINGTON, DC, 20006, US

(21) Appl. No.: 12/298,579

(22) PCT Filed: Apr. 23, 2007
(86) PCT No.: PCT/JP2007/058768

§ 371 Date: Oct. 27, 2008

(30) Foreign Application Priority Data
Apr. 28, 2006 (JP) 2006-125925

(51) Int. Cl. H04L 9/32; H04L 9/08

(52) U.S. Cl. 713/170

(57) ABSTRACT

A communication device is secure against an impersonation attack as well. The communication device secretly communicates, with an external device, target data with use of a key shared with the external device. Without being known to a third party, the communication device generates a key shared with the external device using a scheme of which security is proved. Validity of the external device is determined by authentication with use of a key dependent function that is shared with the external device and is dependent on the shared key. If the external device is determined to be valid, for secretly communicating the target data, verification data for verifying validity of the target data is generated from the target data with use of the key dependent function.

### TECHNICAL FIELD

The present invention relates to an encryption technology as an information security technology, particularly to a technology employing a shared key for secretly communication with a valid communication target.

### BACKGROUND ART

In recent years, there have been increasing opportunities to communicate via a network between consumer electronics, mobile phones and the like. For example, after an authentication key is shared between AV (Audio Visual) devices for copyright protection of content, or between a mobile phone and its communication target for preventing leakage of communication messages, encryption communication is performed using the shared key. Herein, sharing the authentication key means that validity of the communication target is verified by mutual authentication between the devices and that the key is shared between the devices (hereinafter, a key shared between devices is referred to as a shared key).

For example, there is a scheme to share an authentication key called DTCP (Digital Transmission Content Protection) that is used when the AV devices are connected by IEEE 1394 and that is prescribed by copyright protection standard (See Non-patent Document 1). This scheme employs challenge and response authentication using Elliptic Curve DSA signature as the authentication scheme, and Elliptic Curve DH key agreement is used as the key establishment scheme. Non-patent Document 2 discusses, in detail, the challenge and response authentication, Elliptic Curve DSA signature and Elliptic Curve DH key agreement.

In the above-mentioned authentication key agreement scheme called DTCP, security issues, namely existence of effective attacking methods, are not specifically indicated. However, security against all including unknown attacking methods is not yet proved.

Herein, “proving security” means that security of the encryption scheme can be proved not empirically but mathematically. For example, in a public key encryption, when a user not having a private key attempts to decrypt a ciphertext, the proof concerns the necessity for the user to solve a problem whose answer appears to be mathematically difficult to be obtained (e.g. prime factorization problem and elliptic discrete logarithm problem). If this can be proved, it can be indicated that the decryption of the ciphertext is more difficult than the problem whose answer is appeared to be difficult to be obtained. Accordingly, when this can be proved, the public key encryption is proved to be secure.

If the security cannot be proved, the security of the encryption scheme can be guaranteed only to an empirically “probably-tough-to-decrypt” level, which disturbs the user to employ the encryption scheme. For that reason, the user cannot use the conventional authenticated key establishment scheme without a sense of security.

Therefore, a suggestion is made concerning an authentication key agreement scheme that employs a key encapsulation mechanism (hereinafter, referred to as KEM) that is a key distribution scheme whose security has been proved (see Patent Document 1). Since this technology prevents leakage of keys, a user can share the authentication key with a sense of security.

### Patent Document 1 International Publication WO No. 05/039100

Non-patent Document 1: White paper of DTCP Specification <URL: http://www.dtcp.com/data/spec.html>
Non-patent Document 2: Tatsuaki Okamoto, Hirosuke Yamamoto, “Gendai Ango,” published by Sangyo Tosho (1997)

### DISCLOSURE OF THE INVENTION

### Problems the Invention is Attempting to Solve

Unfortunately, in the authentication key agreement scheme employing KEM, although the security against the leakage of a shared key is proved, the security against an impersonation attack as follows is not yet proved. An attacker impersonates a user (device) which is a communication target of the attacker to cause leakage of information of the valid user (device), and disturbs the communication target to communicate.

Accordingly, since a device which is a transmitting source of data may transmit the data to an invalid device that impersonates the valid device, the system as a whole is not secure enough due to the following reason.

For example, even if the security against the leakage of a shared key is guaranteed and if it is difficult to estimate the shared key from each piece of data encrypted by the shared key, collection of large quantity of encrypted data sometimes facilitates the estimation of the shared key.

Accordingly, it is desirable that the authentication key agreement is secure against the impersonation attack. Furthermore, there is desirably a security guarantee for defense against not only the leakage of the shared key but also the impersonation attack.

Therefore, it is an object of the present invention to provide a communication device and a communication system whose security against impersonation attacks can be proved.

### Means for Solving the Problems

To achieve the above object, the present invention provides a communication device that secretly communicates, with a valid external device, target data using a key shared with the valid external device, the communication device including a key generation unit operable to generate a key using, in conjunction with an external device, a scheme of which security is proved, the key being shared with the external device if the external device is valid, a determination unit operable to determine whether the external device is valid by performing authentication with use of a key dependent function depending on the key and being shared with the valid external device; and a data generation unit operable, if the determination unit-determines that the external device is valid, to generate verification data from target data with use of the key dependent function for secretly communicating the target data, the verification data being for verifying validity of the target data.

### EFFECTS OF THE INVENTION

With the above configuration, the communication device performs authentication with use of the shared key and the key dependent function, and generates the verification data with use of the shared key and the key dependent function. Thus, the impersonation attack can be prevented due to the following reason.

When the communication device is under an impersonation attack at the point of authentication, the authentication determines that the external device is invalid. Thus, the impersonation attack can be prevented by not transmitting the target data after this authentication.

In addition, on condition that, after the authentication, an impersonation attack is made on the communication device in order for the communication device to receive target data from an invalid device, although the communication device receives the target data from the invalid device, if it is evident that the device transmitting the data is invalid, what the communication device does is only to abandon the received target data. Even on such condition, verification data is transmitted from the invalid device so as to verify the validity of the target data. However, since the invalid device does not have the shared key or the key dependent function dependent on the shared key, the invalid device cannot transmit the valid verification data. Even if the communication device receives the verification data from the invalid device, since the received verification data is not generated based on the key dependent function that is dependent on the shared key owned by the communication device, the received verification data is different from the verification data generated by the communication device. Accordingly, the invalidity of the target data can be determined, which is to say, it can be determined that the device transmitting the target data is invalid. Thus, when the invalidity of the device transmitting the target data is determined, the communication device abandons the received target data, which prevents the communication device from the impersonation attack.

Furthermore, since the communication device generates the shared key based on the encryption scheme whose security is proved, the communication device is secure against leakage. Thus, the shared key being secure against the leakage is used by the communication device to perform authentication of the external device and secret communication with the external device, which guarantees the security of the processing.

The following briefly proves the security against an impersonation attack.

At the point of authentication, in order for the communication device to determine the validity of the external device, the valid verification data needs to be generated by the external device. This can be achieved when the identical shared key is shared between the communication device and the external device. However, since the shared key is generated with use of the encryption scheme whose security is proved, it can be mathematically proved that there is very little probability, almost negligible, for the shared key to be leaked, which is to say, there is very little probability that the invalid device obtains the shared key. Therefore, it can also be mathematically proved that the invalid device cannot generate the valid verification data. Accordingly, the security of the communication device against the impersonation attack can be proved.

Herein, the key generation unit may generate first key data, share, with the external device, the first key data and second key data generated by the external device by secretly transmitting the first key data to the external device and secretly receiving the second key data from the external device, and generate the key with use of the first key data and the second key data.

With this configuration, since the communication device generates the shared key with use of the first key data and the second key data that are secretly shared with the external device, the shared key is not leaked to outside.

Herein, the authentication may be challenge and response authentication, and the determination unit may receive response data from the external device and perform the challenge and response authentication using the response data and challenge data. The response data is generated by applying the key dependent function to the challenge data and the key, and the challenge data is identical with the first key data.

With this configuration, the communication device does not need to retransmit the challenge data during the challenge and response authentication, which reduces communication traffic.

Herein, the key generation unit may calculate key data by performing an EXCLUSIVE-OR operation of the first key data and the second key data, and generate the key from the calculated key data.

With this configuration, the communication device calculates shared key data based on the EXCLUSIVE-OR operation of the first key data and the second key data, which hampers the first key data and the second key data from being obtained frog the shared key data.

Herein, the key generation unit may use part of the calculated key data as the key.

With this configuration, the communication device can generate the shared key using part of the shared key data.

Herein, the key generation unit may use an entirety of the calculated key data as the key.

With this configuration, the communication device does not need to regenerate the shared key, for the shared key is identical with the shared key data. Thus, the throughput of the communication device can be reduced.

Herein, the key generation unit may generate key data by applying the key dependent function to the first key data and the second key data, and generate the key from the calculated key data.

With this configuration, the communication device converts the first key data and the second key data to the shared key data by the application of the function, which prevents leakage of the first key data and the second key data.

Herein, the key dependent function may be a one-way function dependent on the key.

With this configuration, the communication device generates the shared key data with use of the one-way function. This makes it difficult to generate the first key data and the second key data from the generated shared key data, which improves the security against the leakage of the first key data and the second key data.

Herein, the key may be a verification key used for the authentication of the external device and the generation of the verification data. The key generation unit may further generate an encryption key from the key data. The encryption key is shared with the external device if the external device is valid and is used for encryption and decryption of the target data. The communication device may further include a transmission unit operable to encrypt the target data with use of the encryption key to generate encrypted data, and to transmit the encrypted data and the verification data to the external device.

With this configuration, the communication device generates encrypted data by encrypting the target data with use of the encryption shared key to be shared with the external device and transmits the generated encrypted data to the external device, which does not cause leakage of the target data.

Herein, the key may be a verification key used for the authentication of the external device and the generation of the verification data. The key generation unit may further generate an encryption key from the key data. The encryption key is shared with the external device if the external device is valid and is used for encryption and decryption of the target data. The communication device may further include a recipient unit operable to receive encrypted data from the external device. The encrypted data is the target data having been encrypted with use of the encryption key. The data generation unit may decrypt the received encrypted data to generate decrypted data, and generate verification data using the decrypted data as the target data.

With this configuration, the communication device generates the verification data from the decrypted data having been decrypted with use of the encryption shared key to be shared with the external device. Therefore, as long as the valid shared encryption key and the valid shared verification key are not shared with the external device, the valid decrypted data and the valid verification data cannot be obtained. That is to say, only the valid communication device is able to obtain the decrypted data and the verification data.

Herein, the key generation unit may generate the key with use of a key encapsulation mechanism to distribute the key.

With this configuration, the communication device generates the shared key with use of the key encapsulation mechanism, which does not cause leakage of the shared key.

In addition, since the key encapsulation mechanism ensures the security against the key leakage, at the point of the authentication, the security against the impersonation attack can be proved.

### BRIEF DESCRIPTION OF THE DRAWINGS

FIG. 1 shows an overview of an encryption communication system 1;

FIG. 2 is a block diagram showing a configuration of an encryption communication device A10;

FIG. 3 is a block diagram showing a configuration of an encryption communication device B20;

FIG. 4 is a flow chart showing an operation of the encryption communication system 1, the chart continued to FIG. 5;

FIG. 5 is a flow chart showing the operation of the encryption communication system 1, the chart continued from FIG. 4 and to FIG. 6;

FIG. 6 is a flow chart showing the operation of the encryption communication system 1, the chart continued from FIG. 5 to FIG. 7; and

FIG. 7 is a flow chart showing the operation of the encryption communication system 1, the chart continued from FIG. 6.

### REFERENCE NUMERALS

1 encryption communication system
10 encryption communication device A
20 encryption communication device B
30 channel
101, 201 IO unit
102, 202 transmitter and recipient unit
103, 203 public key storage unit
104, 204 private key storage unit
105, 205 KEM ciphertext generation unit
106, 206 KEM ciphertext decryption unit
107, 207 shared key generation unit
108, 208 shared key storage unit
109, 209 challenge data generation unit
110, 210 response data generation unit
111, 211 response data verification unit
112, 212 MAC generation unit
113, 213 common key encryption unit
114, 214 common key decryption unit
115, 215 DEM ciphertext generation unit
116, 216 DEM ciphertext decryption unit

### BEST MODE FOR CARRYING OUT THE INVENTION

### 1. Embodiment 1

The following describes an encryption communication system 1 in accordance with Embodiment 1 of the present invention.

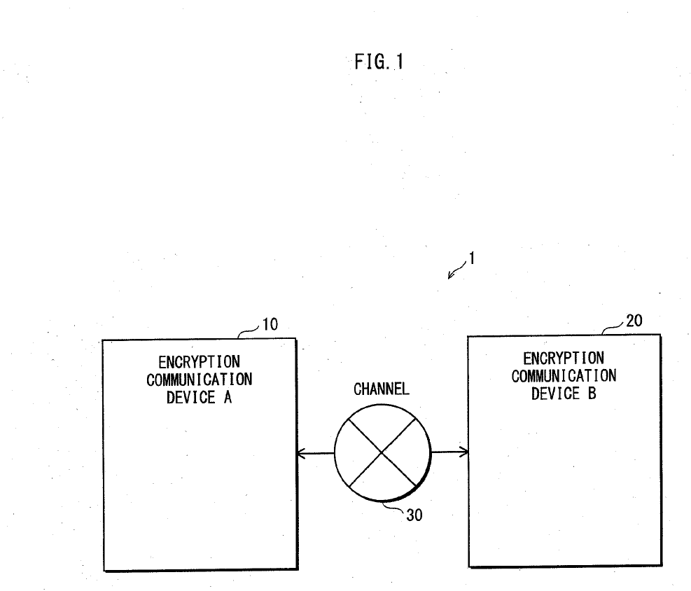

As shown in FIG. 1, the encryption communication system 1 is composed of an encryption communication device A10 and an encryption communication device B20. The encryption communication devices A10 and B20 communicate with each other via a channel 30.

The encryption communication device A10 and the encryption communication device B20 perform encryption communication with each other with the use of a key shared with each other, preventing leakage of a key and an impersonation attack.

The encryption communication between the encryption communication devices A10 and B20 is operated roughly in three phases.

The first phase is where the encryption communication devices A10 and B20 perform mutual authentication and key distribution so that the key is shared between the devices.

The second phase is where the encryption communication devices A10 and B20 confirm each other that an impersonation attack is not made by performing challenge and response authentication with use of the shared key.

The third phase is where encrypted data is transmitted and received, via the channel 30, between the encryption communication devices A10 and B20.

Herein, the data is, for example, text data, music data, image data, and moving picture content data.

### 1.1 Preparation

The following describes the key encapsulation mechanism (hereinafter, referred to as KEM) that is one of key distribution schemes and that is employed in this embodiment.

To put it briefly, the key encapsulation mechanism is an algorithm for distributing a shared key between a transmitter device and a recipient device with use of public key encryption. First, the transmitter inputs a public key pk to a public key encryption algorithm E, generates a ciphertext C and a shared key K, and transmits the ciphertext C to the recipient. Then, the recipient inputs a private key sk and the ciphertext C to a public key decryption algorithm D, and obtains the identical shared key K with the transmitter. Note that in this description, the ciphertext C is also referred to as “KEM ciphertext of the key data K” and the like.

The object of the key encapsulation mechanism is as follows. By sharing the shared key K between the transmitter device and the recipient device using the key encapsulation mechanism, subsequently communication data that is transmitted from the transmitter device to the recipient device is encrypted by common key cryptosystem using the shared key K. The feature that cannot be found in a conventional key distribution scheme is that fraud made by the transmitter is prevented because while information is transmitted unilaterally from the transmitter device to the recipient device, the transmitter cannot deliberately create the shared key.

An algorithm called PSEC-KEM is disclosed as an example of such a key encapsulation mechanism.

Note that the detailed description of the PSEC-KEM algorithm is omitted here, for its detail is described in “Generic conversions for constructing IND-CCA2 public-key encryption in the random oracle model” written by Tatsuaki Okamoto. The following is a brief description of the PSEC-KEM algorithm.

### (1) System Parameter of PSEC-KEM

PSEC-KEM has the following system parameter.
elliptic curve: E
point of order n on elliptic curve E: P
hash function: G, H

Note that the detailed description of the elliptic curve, order and hash function is omitted here, for the detailed description is disclosed in Non-patent Document 2.

Note that the hash functions G and H are shared between both the transmitter and the recipient.

### (2) Public Key and Private Key in PSEC-KEM

An element x of Zn is chosen at random, thereby generating W=x*P.

Herein, Zn is a group of {0, 1, . . . , n−1}, and x*P indicates a point on the elliptic curve obtained from the x-time addition of the point P on the elliptic curve E. Note that Non-patent Document 2 describes the addition method of the point on the elliptic curve.
The public key pk is represented by (E, P, W, n), and the private key sk is represented by x.

### (3) Encryption of PSEC-KEM

For encryption, the public key pk is inputted in the public key encryption algorithm KemE that is described below, and the shared key K and the ciphertext C are outputted.

The following describes the public key encryption algorithm KemE.
An element s of Zn is generated at random.
G(s) is generated, and G(s) is separated into G(s)=a∥K. The “∥” represents concatenation of bits. The separation of G(s) into G(s)=a∥K means that a plurality of high-order bits of G(s) are represented as a, and the rest of the bits are represented as K.
R=a*P, and Q=a*W are generated.
v=s xor H (R∥Q) is generated. Herein, the xor represents an EXCLUSIVE-OR operation.
The shared key K and the ciphertext C=(R, v) are outputted.
The transmitter device transmits the ciphertext C to its communication target (the recipient device).

### (4) Decryption of PSEC-KEM

The recipient device receives the ciphertext C from the transmitter device, and outputs the shared key K by inputting the ciphertext C=(R, v) and the private key sk in the public key decryption algorithm KemD that is described below.

The following describes the public key decryption algorithm KemD.
Q=x*R is generated. As described above, x represents the private key sk.
s′=v xor H (R∥Q) is generated. Herein, v and R can be obtained from the ciphertext C.
G(s′) is generated, and G(s′) is separated into G(s′)=a′∥K′. Here, the separation method is similar to that used for the encryption.
Whether R=a′*P holds true is verified. If the expression is true, K′ is outputted as the shared key K.

The following describes when this PSEC-KEM algorithm is applied to an encryption scheme where the encryption communication is performed between the transmitter device and the recipient device. First, the transmitter device obtains the public key pk of the recipient device that is its communication target. The shared key K and the ciphertext C are obtained by input of the obtained public key pk to the aforementioned public key encryption algorithm KemE, and the ciphertext C is transmitted to the recipient device. Subsequently, the recipient device receives the ciphertext C from the transmitter device, inputs the received ciphertext C and the private key sk that is owned by the recipient device to the public key decryption algorithm KemD, and obtains the shared key K identical with that obtained by the transmitter device.

The following describes the above in detail.

Now, in PSEC-KEM algorithm, (a*P∥a*W) is the input of the hash function H. In the public key encryption algorithm KemE, the component s generated at random is functioned by a value of H (a*P∥a*W), thereby generating v. Subsequently, in public key decryption algorithm KemD, Q=x*R=x*(a*P)=a*(x*P)=a*W can be obtained from R=a*P contained in the ciphertext C with use of the private key sk (=x). Accordingly, by calculating v xor H (a*P∥a*W), the component s generated at random in the public key encryption algorithm KemE can be obtained. Herein, v xor H (a*P∥a*W) is an inverse operation of the operation by which public key encryption algorithm KemE calculates v from s. Accordingly, both in the public key encryption algorithm KemE and the public key decryption algorithm KemD, the same value s can be inputted into the hash function G, and the same shared key K can be obtained. As a result, the recipient device having the private key sk can obtain the same shared key K as the one obtained by the transmitter device.

On the other hand, if other recipient devices that does not know the private key sk should obtain the public key pk and receive the ciphertext C, since the private key sk (=x) is unknown, Q=a*W(=(ax)*P) cannot be calculated from R=a*P. Thus, the other recipient devices cannot obtain the same shared key K as the transmitter device due to the following reason. Since the other recipient devices that do not know the private key sk can use solely the public key pk, the other recipient devices use W=x*P contained in the public key pk instead of the private key sk (=x) to calculate the above Q expression. In general, the calculation of Q=a*W(=(ax)*P) from a*P and W=x*P is called Diffie-Hellman problem over the ecliptic curve, because the calculation is difficult unless the values of a and x are known. Note that since this is described in “Algebraic Aspects of Cryptography” written by Neal Koblitz (Algorithms and Computation in Mathematics Vol. 3, pp. 132-133, Springer-Verlag, 1998), the description of this is omitted here.

That is to say, in the PSEC-KEM algorithm, the Diffie-Hellman problem where the calculation of a*W from a*P without using a private key is difficult is used to eventually obtain the shared key K. Thus, if the private key is unknown, the shared key K cannot be obtained.

Thus, according to the above, the transmitter device and the recipient device can secretly share the shared key K. Subsequently, communication data that is transmitted from the transmitter device to the recipient device can be encrypted by the common key cryptosystem using the shared key K.

It is proved with regard to the abovementioned PSEC-KEM algorithm that if the aforementioned Diffie-Hellman problem over the ecliptic curve is difficult, the recipient device that does not know the private key cannot obtain the shared key K. This proof is called “securityproof,” for the security of the system is proved. Security of other KEM algorithm than PSEC-KEM, such as RSA-KEM and NTRU-KEM (See Japanese published unexamined application 2004-201292, and Japanese published unexamined application 2004-201293), are also proved based on the similar difficult mathematical problems.

Note that since the detail of RSA-KEM is described in “A proposal for an ISO standard for public key encryption (version 2.1),” written by Victor Shoup, the description is omitted here.

In addition, since the detail of NTRU-KEM is described in Japanese published unexamined application 2004-201292 and Japanese published unexamined application 2004-201293, the detailed description is omitted here.

With use of the aforementioned KEM, a KEM ciphertext is bilaterally transmitted between the two encryption communication devices. In this case, the shared key K is created with use of both a shared key (referred to as KA) that is shared by transmitting the KEM ciphertext from the encryption communication device A to the other encryption communication device B and a shared key (referred to as KB) that is shared by transmitting the KEM ciphertext from the encryption communication device B to the encryption communication device A, which enables the devices to share the key more securely.

In the encryption communication system 1, a key is shared by the bilateral transmission of a KEM ciphertext as mentioned above.

The following describes encryption communication devices A10 and B20 configuring the encryption communication system 1 and operations of the encryption communication devices A10 and B20.

### 1.2 Configuration of Encryption Communication Device A10

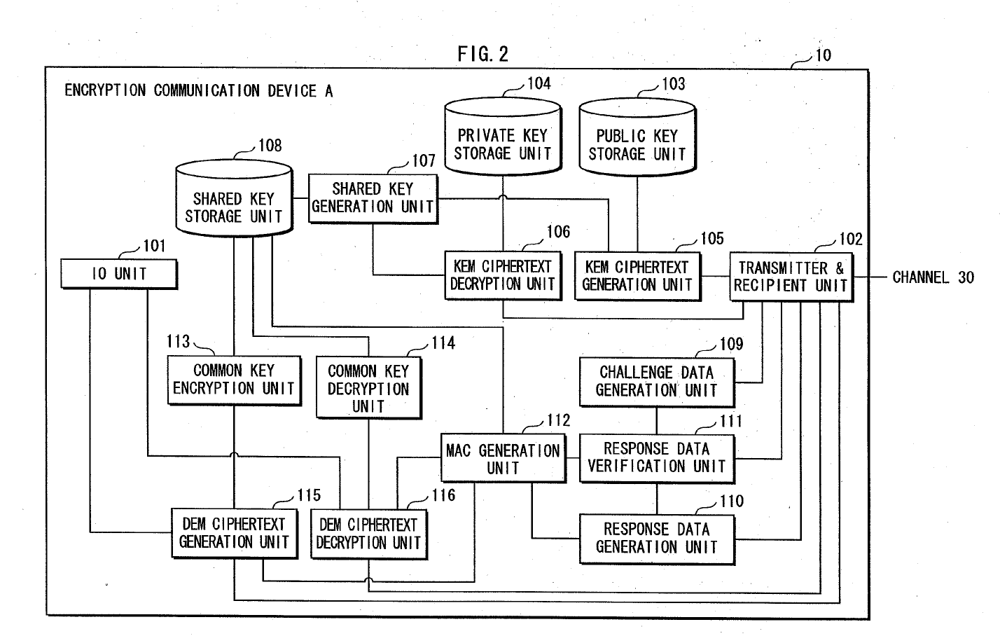

As shown in FIG. 2, the encryption communication device A10 includes an IO (Input/Output) unit 101, a transmitter and recipient unit 102, a public key storage unit 103, a private key storage unit 104, a KEM ciphertext generation unit 105, a KEM ciphertext decryption unit 106, a shared key generation unit 107, a shared key storage unit 108, a challenge data generation unit 109, a response data generation unit 110, a response data verification unit 111, an MAC (Message Authentication Code) generation unit 112, a common key encryption unit 113, a common key decryption unit 114, a DEM (Data Encapsulation Mechanism) ciphertext generation unit 115 and a DEM ciphertext decryption unit 116.

### (1) Public Key Storage Unit 103

The public key storage unit 103 stores therein a public key KPB of the encryption communication device B20.

Note that the public key KPB as well as a private key KSB is given in advance being associated with the encryption communication device B20. In addition, in the encryption communication device A10, the public key KPB is given in advance from the outside and stored therein. Alternatively, the public key KPB is transmitted from the encryption communication device B20 and is received in advance via the channel 30 and stores therein.

### (2) Private Key Storage Unit 104

The private key storage unit 104 stores therein a private key KSA of the encryption communication device A10.

Note that the private key KSA as well as a public key KPA is given in advance being associated with the encryption communication device A10.

### (3) KEM Ciphertext Generation Unit 105

The KEM ciphertext generation unit 105 generates key data KA and a KEM ciphertext KEMA corresponding to the key data KA with use of the public key KPB and the public key encryption algorithm KemE of the key encapsulation mechanism (KEM). Since generation method of the key data KA and the KEM ciphertext KEMA is similar to the aforementioned PSEC-KEM encryption, the description is omitted here.

The KEM ciphertext generation unit 105 transmits the generated KEM ciphertext KEMA to the encryption communication device B20 via the transmitter and recipient unit 102.

The KEM ciphertext generation unit 105 outputs the generated key data KA to the shared key generation unit 107.

### (4) KEM Ciphertext Decryption Unit 106

The KEM ciphertext decryption unit 106 receives, via the transmitter and recipient unit 102 of the encryption communication unit B20, the KEM ciphertext KEMB that is a ciphertext of the key data KB-encrypted by the public key encryption algorithm KemE of KEM.

The KEM ciphertext decryption unit 106 inputs the private key KSA and the KEM ciphertext KEMB to the public key decryption algorithm KemD corresponding to the public key encryption algorithm KemE, decrypts the received KEM ciphertext KEMB, and generates the key data KB. Since the decryption method of the key data KB is similar to the aforementioned PSEC-KEM decryption method, the description is omitted here.

The KEM ciphertext decryption unit 106 outputs the generated key data KB to the shared key generation unit 107.

### (5) Shared Key Generation Unit 107

The shared key generation unit 107 receives the key data KA from the KEM ciphertext generation unit 105 and the key data KB from the KEM ciphertext decryption unit 106.

The shared key generation unit 107 generates a shared key KS used for the common key cryptosystem and a shared key KH for MAC with use of the received key data KA and KB, and the generated shared common key KS and the shared MAC key KH are stored in the shared key storage unit 108.

The following describes a specific example of generation of the shared common key KS and the shared MAC key KH.

The shared key generation unit 107 performs an XOR operation of the key data KA and KB, and generates shared key data K. The shared key generation unit 107 uses part of the generated shared key data K as the shared common key KS and other part as the shared MAC key KH. That is to say, with regard to the generated shared key data K, the key generation unit 107 may obtain the shared common key KS and the shared MAC key KH to satisfy K=KS∥KH. Herein, “∥” represents concatenation. The compartmental location to obtain the shared common key KS and the shared MAC key KH from the shared data K may be at anywhere as long as the compartmental location is in accordance with the encryption communication device B20.

Note that the generation method of the shared key data K may be anything as long as information of both the key data KA and KB are contained. For example, a hash function value of data K′ that is concatenation of bits or bytes of key data KA and KB may be the shared key data K.

### (6) Shared Key Storage Unit 108

The shared key storage unit 108 has an area to store therein the shared common key KS and the shared MAC key KH generated by the shared key generation unit 107.

### (7) Challenge Data Generation Unit 109

The challenge data generation unit 109 generates challenge data nA that is a random number, and transmits the generated challenge data nA to the encryption communication device B20, via the transmitter and recipient unit 102.

The challenge data generation unit 109 temporally stores therein the generated challenge data nA.

### (8) Response Data Generation Unit 110

The response data generation unit 110 receives, via the transmitter and recipient unit 102 from the encryption communication device B20, challenge data nB and response data rB corresponding to the challenge data nA transmitted by the challenge data generation unit 109. Alternatively, the response data 110 receives solely the challenge data nB.

### (When Receiving the Challenge Data nB and the Response Data rB)

When receiving the challenge data nB and the response data rB from the encryption communication device B20, the response data generation unit 110 temporally stores therein the received challenge data nB.

The response data generation unit 110 outputs the response data rB and a verification instruction instructing to verify the response data to the response data verification unit 111.

When receiving the response data generation instruction instructing to generate response data from the response data verification unit 111, the response data generation unit 110 outputs a MAC generation instruction instructing to generate Message Authentication Code (MAC) and the temporally stored challenge data nB to the MAC generation unit 112.

When receiving a MAC value HnB from the MAC generation unit 112, the response data generation unit 110 transmits the received MAC value HnB as the response data rA to the encryption communication device B20, via the transmitter and recipient unit 102.

Note that the MAC value HnB is later described in the description of the MAC generation unit 112.

### (When Receiving Solely the Challenge Data nB)

When receiving the challenge data nB from the encryption communication device B20, the response date generation unit 110 outputs the MAC generation instruction and the received challenge data nB to the MAC generation unit 112.

When receiving the MAC value HnB from the MAC generation unit 112, the response data generation unit 110 transmits the received MAC value HnB as the response data rA together with the challenge data nA generated by the challenge data generation unit 109 to the encryption communication device B20 via the transmitter and recipient unit 102.

### (9) Response Data Verification Unit 111

When receiving the verification instruction and the response data rB from the response data generation unit 110, the response data verification unit 111 obtains the challenge data nA that is temporally stored in the challenge data generation unit 109.

The response data verification unit 111 outputs the MAC generation instruction and the obtained challenge data nA to the MAC generation unit 112.

When receiving a MAC value HnA from the MAC generation unit 112, the response data verification unit 111 determines whether the MAC value HnA and the response data rB match each other.

When it is determined that the MAC value HnA and the response data rB match each other, the response data verification unit 111 outputs the response data generation instruction to the response data generation unit 110.

When it is determined that the MAC value HnA and the response data rB do not match each other, the response data generation unit 110 terminates the entire processing pertaining the encryption communication.

When receiving the response data rB via the transmitter and recipient unit 102 from the encryption communication device B20, the response data verification unit 111 obtains the challenge data nA temporally stored in the challenge data generation unit 109 and performs verification of the response data rB by the similar operation to the above.

### (10) MAC Generation Unit 112

The MAC generation unit 112 pre-stores therein a keyed hash function Hash. The keyed hash function is whose input is a key and data and is a one-way function depending on the key. The keyed hash function Hash employed in this embodiment uses the shared MAC key KH and is a function depending on the shared MAC key KH. Since the detail of the keyed hash value is described in pages 189-195 of Non-patent Document 2, the description is omitted here.

The MAC generation unit 112 generates (calculates), from MAC target data, a message authentication code value (MAC value) with a given bit length t (t is 1 or more) with use of the shared MAC key KH stored in the shared key storage unit 108.

Herein, a MAC value for the MAC target data DM is HDM=Hash (KH, DM). In addition, Hash (KH, DM) indicates a hash value of data DM calculated by the keyed hash function Hash with the use of the shared MAC key KH.

When receiving the MAC generation instruction and the challenge data nB from the response data generation unit 110, the MAC generation unit 112 obtains the shared MAC key KH stored in the shared key storage unit 108. The MAC generation unit 112 calculates the MAC value HnB (=Hash (KH, nB)) of the challenge data nB with use of the pre-stored keyed hash function Hash and the obtained KH, and outputs the calculated MAC value HnB to the response data generation unit 110.

When receiving the MAC generation instruction and the challenge data nA from the response data verification unit 111, the MAC generation unit 112 obtains the shared MAC key KH stored in the shared key storage unit 108. The MAC generation unit 112 calculates the MAC value HnA (=Hash (KH, nB)) of the challenge data nA with use of the pre-stored keyed hash function Hash and the obtained KH, and outputs the calculated MAC value HnA to the response data verification unit 111.

When receiving the MAC generation instruction and transmission data DA (hereinafter, referred to as encryption target data) to be encrypted by the common key cryptosystem and to be transmitted to the encryption communication device B20 from the DEM ciphertext generation unit 115, the MAC generation unit 112 obtains the shared MAC key KH stored in the shared key storage unit 108. The MAC generation unit 112 calculates the MAC value HDA (=Hash (KH, DA)) of the encryption target data DA with use of the pre-stored keyed hash function Hash and the obtained KH, and outputs the calculated MAC value HDA to the DEM ciphertext generation unit 115.

When receiving the MAC generation instruction and decrypted data DB′ from the DEM ciphertext decryption unit 116, the MAC generation unit 112 obtains the shared MAC key KH stored in the shared key storage unit 108. The MAC generation unit 112 calculates a MAC value HDB′ (=Hash (KH, DB′)) of the decrypted data DB′ with use of the pre-stored keyed hash function Hash and the obtained KH, and outputs the calculated MAC value HDB′ to the DEM ciphertext generation unit 115.

The decrypted data DB′ is later described in the description of the common key decryption unit 114.

Note that Hash (KH, DM) may be Hash (KH, DM)=SHA1 (KH∥DM). Herein, SHA1(x) is a SHA1 hash function value of x, and the “∥” represents concatenation.

### (11) Common Key Encryption Unit 113

When receiving the encryption target data DA and an encryption instruction instructing to encrypt the encryption target data DA from the DEM ciphertext generation unit 115, the common key encryption unit 113 obtains the shared common key KS stored in the shared key storage unit 108.

The common key encryption unit 113 encrypts the encryption target data DA with use of the obtained shared common key KS and common key cryptosystem algorithm, and generates encrypted data EDA (=Enc (KS, DA)) of the encryption target data DA. Herein, Enc (KS, DA) means a ciphertext of the data DA that is encrypted by the common key cryptosystem with use of the key KS. The common key cryptosystem is, for example, DES cryptosystem or AES cryptosystem. Since the detail of the common key cryptosystem is disclosed in pages 79-105 of Non-patent Document 2, the description is omitted.

The common key encryption unit 113 outputs the generated encrypted data Enc (KS, DA) to the DEM ciphertext generation unit 115.

(12) Common Key Decryption unit 114

When receiving encrypted data EDB (=Enc (KS, DB)) of the encryption target data DB encrypted by the shared common key KS and a decryption instruction instructing to decrypt the encrypted data from the DEM ciphertext decryption unit 116, the common key decryption unit 114 obtains the shared common key KS stored in the shared key storage unit 108.

The common key decryption unit 114 decrypt the encrypted data Enc (KS, DB) with use of the obtained shared common key KS and the shared key decryption algorithm, and generates the decrypted data DB′.

The common key decryption unit 114 outputs the generated decrypted data DB′ to the DEM ciphertext decryption unit 116.

### (13) DEM Ciphertext Generation Unit 115

When receiving the encryption target data DA via the IO unit 101 from the outside, the DEM ciphertext generation unit 115 outputs the encryption instruction and the received encryption target data DA to the common key encryption unit 113.

The DEM ciphertext generation unit 115 outputs the MAC instruction and the received encryption target data DA to the MAC generation unit 112.

When receiving the encrypted data EDA (=Enc (KS, DA)) from the common key encryption unit 113 and the MAC value HDA (=Hash (KH, DA)) from the MAC generation unit 112, the DEM ciphertext generation unit 115 concatenates the encrypted data EDA (=Enc (KS, DA)) with the MAC value HDA (=Hash (KH, DA)), thereby generating a DEM ciphertext DEMA (=Enc (KS, DA)∥HDA).

The DEM ciphertext generation unit 115 transmits the generated DEM ciphertext DEMA to the encryption communication device B20 via the transmitter and recipient unit 102.

### (14) DEM Ciphertext Decryption Unit 116

The DEM ciphertext decryption unit 116 receives the DEM ciphertext DEMB (=EDB∥HDB) from the encryption communication device B20 via the transmitter and recipient unit 102. Herein, EDB is encrypted data (Enc (KS, DE)) of the encryption target data DB encrypted by the shared common key KS owned by the encryption communication device B20. HDB is a MAC value (Hash (KH, DB)) of the encryption target data DB.

The DEM ciphertext decryption unit 116 separates the received DEM ciphertext DEMB (=EDB∥HDB) into the encrypted data EDB and the MAC value HDB.

The following illustrates an example of the separation. When a bit length of the DEM ciphertext DEMB is u, as mentioned above, since the bit length of the MAC value HDB is t, it is obvious that u>t. The DEM ciphertext decryption unit 116 extracts data of u−t bit length from the top of the DEM ciphertext DEMB. The extracted data is the encrypted data EDB, and data of the remaining t-bit length is the MAC value HDB.

The DEM ciphertext decryption unit 116 outputs the decryption instruction and the encrypted data EDB (=Enc (KS, DB)) to the common key decryption unit 114.

When receiving the decrypted data DB′ from the common key decryption unit 114, the DEM ciphertext decryption unit 116 outputs the MAC instruction and the decrypted data DB′ to the MAC generation unit 112.

When receiving the MAC value HDB′ (=Hash (KH, DB′)), the DEM ciphertext decryption unit 116 compares HDB separated from the DEM ciphertext DEMB, and determines whether the MAC value HDB′ matches HDB.

When it is determined the MAC values HDB′ and HDB match each other, the DEM ciphertext decryption unit 116 outputs the encrypted data DB′, namely the encryption target data DB, to the outside via the IO unit 101.

When it is determined that the MAC value HDB′ does not match HDB, the DEM ciphertext decryption unit 116 terminates the entire processing pertaining the encryption communication.

### (15) IO Unit 101

The IO unit 101 receives the encryption target data DA from the outside, and outputs the received encryption target data DA to the DEM ciphertext generation unit 115.

When receiving the decrypted data DB′ from the DEM ciphertext decryption unit 116, the IO unit 101 outputs the received decrypted data DB′ to the outside.

### (16) Transmitter and Recipient Unit 102

When receiving the KEM ciphertext KEMA from the KEM ciphertext generation unit 105, the transmitter and recipient unit 102 transmits the received KEM ciphertext KEMA to the encryption communication device B20 via the channel 30.

When receiving the KEM ciphertext KEMB from the encryption communication device B20 via the channel 30, the transmitter and recipient unit 102 outputs the received KEM ciphertext KEMB to the KEM ciphertext decryption unit 106.

When receiving the challenge data nA from the challenge data generation unit 109, the transmitter and recipient unit 102 transmits the received challenge data nA to the encryption communication device B20 via the channel 30.

When receiving the response data rA from the response data generation unit 110, the IO unit 102 transmits the received response data rA to the encryption communication device B20 via the channel 30.

When receiving the challenge data nB and the response data rB, alternatively solely the challenge data nB, from the encryption communication device B20 via the channel 30, the IO unit 102 outputs the challenge data nB and the response data rB, alternatively solely the challenge data nB, to the response data generation unit 110.

When receiving the response data rB from the encryption communication device B20 via the channel 30, the transmitter and recipient unit 102 outputs the received response data rB to the response data verification unit 111.

When receiving the DEM ciphertext DEMA from the DEM ciphertext generation unit 115, the transmitter and recipient unit 102 transmits the received DEM ciphertext DEMA to the encryption communication device B20 via the channel 30.

When receiving the DEM ciphertext DEMB from the encryption communication device B20 via the channel 30, the transmitter and recipient unit 102 outputs the received DEM ciphertext DEMB to the DEM ciphertext decryption unit 116.

### 1.3 Configuration of Encryption Communication Device B20

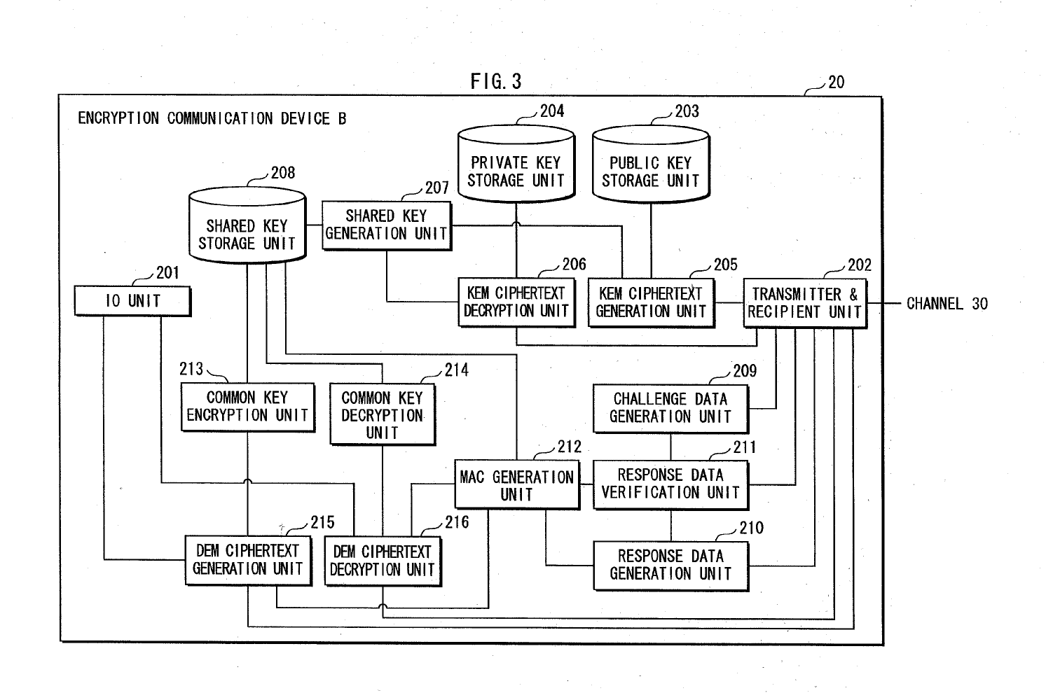

As shown in FIG. 3, the encryption communication device B20 includes an IO unit 201, a transmitter and recipient unit 202, a public key storage unit 203, a private key storage unit 204, a KEM ciphertext generation unit 205, a KEM ciphertext decryption unit 206, a shared key generation unit 207, a shared key storage unit 208, a challenge data generation unit 209, a response data generation unit 210, a response data verification unit 211, a MAC generation unit 212, a common key encryption unit 213, a common key decryption unit 214, a DEM ciphertext generation unit 215 and a DEM ciphertext decryption unit 216.

### (1) Public Key Storage Unit 203

The public key storage unit 203 stores the public key KPA of the encryption communication device A10.

Note that the public key KPA as well as the private key KSA is given in advance being associated with the encryption communication device A10. In addition, as for the encryption communication device B20, the public key KPA is given in advance from the outside and stored in the encryption communication device B20. Alternatively, the encryption communication device B20 receives, in advance, the public key KPA transmitted from the encryption communication device A10 via the channel 30 and stores the public key KPA therein.

### (2) Private Key Storage Unit 204

The private key storage unit 204 stores the private key KSB of the encryption communication device B20.

Note that the private key KSB as well as the public-key KPB is given in advance being associated with the encryption communication device B20.

### (3) KEM Ciphertext Generation Unit 205

The KEM ciphertext generation unit 205 generates the key data KB and the KEM ciphertext KEMB of the key data KB with use of the public key KPA and the public key encryption algorithm KemE of the key encapsulation mechanism (KEM). Since generation methods of the key data KB and the KEM ciphertext KEMB are similar to the aforementioned PSEC-KEM encryption, its description is omitted here.

The KEM ciphertext generation unit 205 transmits the generated KEM ciphertext KEMB to the encryption communication device A10 via the transmitter and recipient unit 202.

The KEM ciphertext generation unit 205 outputs the generated key data KB to the shared key generation unit 207.

### (4) KEM Ciphertext Decryption Unit 206

The KEM ciphertext decryption unit 206 receives KEM ciphertext KEMA from the encryption communication unit A10 via the transmitter and recipient unit 202.

The KEM ciphertext decryption unit 206 inputs the private key KSB and the KEM ciphertext KEMA to the public key decryption algorithm KemD corresponding the public key encryption algorithm KemE, decrypts the received KEM ciphertext KEMA, and generates the key data KA. Since the decryption method of the key data KA is similar to the aforementioned PSEC-KEM decryption method, its description is omitted here.

The KEM ciphertext decryption unit 206 outputs the generated key data KA to the shared key generation unit 207.

### (5) Shared Key Generation Unit 207

The shared key generation unit 207 receives the key data KB from the KEM ciphertext generation unit 205 and the key data KA from the KEM ciphertext decryption unit 206.

The shared key generation unit 207 generates the shared common key KS and the shared MAC key KH with use of the received key data KA and KB, and stores the generated shared common key KS and the shared MAC key KH in the shared key storage unit 208.

An identical method to the generation method in the shared key generation unit 107 is employed to generate the shared common key KS and the shared MAC key KH.

### (b 6) Shared Key Storage Unit 208

The shared key storage unit 208 has an area to store therein the shared common key KS and the shared MAC key KH generated by the shared key generation unit 207.

### (7) Challenge Data Generation Unit 209

The challenge data generation unit 209 generates challenge data nB that is a random number, and transmits the generated challenge data nB to the encryption communication device B20, via the transmitter and recipient unit 202.

The challenge data generation unit 209 temporally stores therein the generated challenge data nB.

### (8) Response Data Generation Unit 210

The response data generation unit 210 receives, from the encryption communication device A10 via the transmitter and recipient unit 202, the challenge data nA and the response data rA corresponding to the challenge data nB transmitted by the challenge data generation unit 209. Alternatively, the response data generation unit 210 receives solely the challenge data nA.

<When Receiving the Challenge Data nA and the Response Data rA>

In receiving the challenge data nA and the response data rA from the encryption communication device A10, the response data generation unit 210 temporally stores therein the received challenge data nA.

The response data generation unit 210 outputs the response data rA and the verification instruction instructing to verify the response data to the response data verification unit 211.

When receiving the response data generation instruction instructing to generate response data from the response data verification unit 211, the response data generation unit 210 outputs the MAC generation instruction and the temporally stored challenge data nA to the MAC generation unit 212.

When receiving the MAC value HnA from the MAC generation unit 212, the response data generation unit 210 transmits the received MAC value HnA as the response data rB to the encryption communication device A10, via the transmitter and recipient unit 202.

Note that the MAC value HnA is described later in the description of the MAC generation unit 212.

<When Receiving Solely the Challenge Data nA>

When receiving the challenge data nA from the encryption communication device A10, the response date generation unit 210 outputs the MAC generation instruction and the received challenge data nA to the MAC generation unit 212.

When receiving the MAC value HnA from the MAC generation unit 212, the response data generation unit 210 transmits the received MAC value HnA as the response data rB together with the challenge data nB generated by the challenge data generation unit 209 to the encryption communication device B20 via the transmitter and recipient unit 202.

### (9) Response Data Verification Unit 211

When receiving the verification instruction and the response data rA from the response data generation unit 210, the response data verification unit 211 obtains the challenge data nB that is temporally stored in the challenge data generation unit 209.

The response data verification unit 211 outputs the MAC generation instruction and the obtained challenge data nB to the MAC generation unit 212.

When receiving the MAC value HnB from the MAC generation unit 212, the response data verification unit 211 determines whether the MAC value HnB and the response data rA match each other.

When it is determined that the MAC value HnB and the response data rA match each other, the response data verification unit 211 outputs the response data generation instruction to the response data generation unit 210.

When it is determined that the MAC value HnB and the response data rA do not match each other, the response data verification unit 211 terminates the entire processing pertaining the encryption communication.

When receiving the response data rA, from the encryption communication device A10 via the transmitter and recipient unit 202, the response data verification unit 211 obtains the challenge data nB temporally stored in the challenge data generation unit 209 and verifies the response data rA by the similar operation to the above.

### (10) MAC Generation Unit 212

The MAC generation unit 212 pre-stores therein a keyed hash function Hash.

The MAC generation unit 212 generates (calculates), from the MAC target data DM, a MAC value HDM with a given bit length t (t is 1 or more) with use of the shared MAC key KH stored in the shared key storage unit 208. Note that the bit length of the MAC value generated by the MAC generation unit 212 is identical to the bit length of the MAC value generated by the MAC generation unit 112 of the encryption communication device A10.

When receiving the MAC generation instruction and the challenge data nA from the response data generation unit 210, the MAC generation unit 212 obtains the shared MAC key KH stored in the shared key storage unit 208. The MAC generation unit 212 calculates the MAC value HnA (=Hash (KH, nA)) of the challenge data nA with use of the pre-stored keyed hash function Hash and the obtained KH, and outputs the calculated MAC value HnA to the response data generation unit 210.

When receiving the MAC generation instruction and the challenge data nB from the response data verification unit 211, the MAC generation unit 212 obtains the shared MAC key KH stored in the shared key storage unit 208. The MAC generation unit 212 calculates the MAC value HnB (=Hash (KH, nB)) of the challenge data nB with use of the pre-stored keyed hash function Hash and the obtained shared MAC key KH, and outputs the calculated MAC value HnB to the response data verification unit 211.

When receiving the MAC generation instruction and the encryption target data DB to be encrypted and transmitted to the encryption communication device A10 from the DEM ciphertext generation unit 215, the MAC generation unit 212 obtains the shared MAC key KH stored in the shared key storage unit 208. The MAC generation unit 212 calculates the MAC value HDB (=Hash (KH, DB)) of the encryption target data DB with use of the pre-stored keyed hash function Hash and the obtained shared MAC key KH, and outputs the calculated MAC value HDB to the DEM ciphertext generation unit 215.

When receiving the MAC generation instruction and decrypted data DA′ from the DEM ciphertext decryption unit 216, the MAC generation unit 212 obtains the shared MAC key KH stored in the shared key storage unit 208. The MAC generation unit 212 calculates a MAC value HDA′ (=Hash (KH, DA′)) of the decrypted data DA′ with use of the pre-stored keyed hash function Hash and the obtained shared MAC key KH, and outputs the calculated MAC value HDA′ to the DEM ciphertext generation unit 215.

The decrypted data DA′ is later described in the description of the common key decryption unit 214.

### (11) Common Key Encryption Unit 213

When receiving the encryption target data DB and an encryption instruction to encrypt the data DB from the DEM ciphertext generation unit 215, the common key encryption unit 213 obtains the shared common key KS stored in the shared key storage unit 208.

The common key encryption unit 213 encrypts the encryption target data DB with use of the obtained shared common key KS and the common key cryptosystem algorithm, thereby generating encrypted data EDB (=Enc (KS, DB)) of the encryption target data DB. Herein, Enc (KS, DB) means a ciphertext of the data DB that is encrypted by the common key cryptosystem with use of the key KS. The common key cryptosystem is, for example, DES cryptosystem or AES cryptosystem. The common key cryptosystem is disclosed in pages 79-105 of Non-patent Document 2.

The common key encryption unit 213 outputs the generated encrypted data Enc (KS, DB) to the DEM ciphertext generation unit 215.

### (12) Common Key Decryption Unit 214

When receiving encrypted data EDA (=Enc (KS, DA)) that has been obtained by encrypting the encryption target data DA by the shared common key KS and a decryption instruction instructing to decrypt the encrypted data from the DEM ciphertext decryption unit 216, the common key decryption unit 214 obtains the shared common key KS stored in the shared key storage unit 208.

The common key decryption unit 214 decrypts the encrypted data Enc (KS, DA) with use of the obtained shared common key KS and the common key decryption algorithm, thereby generating the decrypted data DA′.

The common key decryption unit 214 outputs the generated decrypted data DA′ to the DEM ciphertext decryption unit 216.

### (13) DEM Ciphertext Generation Unit 215

When receiving the encryption target data DB, from the outside via the IO unit 201, the DEM ciphertext generation unit 215 outputs the encryption instruction and the received encryption target data DB to the common key encryption unit 213.

The DEM ciphertext generation unit 215 outputs the MAC instruction and the received encryption target data DB to the MAC generation unit 212.

When receiving the encrypted data EDB (=Enc (KS, DB)) from the common key encryption unit 213 and the MAC value HDB (=Hash (KH, DB)) from the MAC generation unit 212, the DEM ciphertext generation unit 215 concatenates the encrypted data EDB (=Enc (KS, DB)) with the MAC value HDB (=Hash (KH, DB)), thereby generating the DEM ciphertext DEMB (=Enc (KS, DB)∥HDB).

The DEM ciphertext generation unit 215 transmits the generated DEM ciphertext DEMB to the encryption communication device A10 via the transmitter and recipient unit 202.

### (14) DEM Ciphertext Decryption Unit 216

The DEM ciphertext decryption unit 216 receives the DEM ciphertext DEMA (=EDA∥HDA) from the encryption communication device A10 via the transmitter and recipient unit 202. The EDA is encrypted data (Enc (KS, DA)) of the encryption target data DA encrypted by the shared common key KS owned by the encryption communication device A10. The HDA is the MAC value (Hash (KH, DA)) of the encryption target data DA.

The DEM ciphertext decryption unit 216 separates the received DEM ciphertext DEMA (=EDA∥HDA) into the encrypted data EDA and the MAC value HDA. Note that the DEM ciphertext decryption unit 216 employs the identical method for separating the DEM ciphertext DEMA to that employed by the aforementioned DEM ciphertext decryption unit 116.

The DEM ciphertext decryption unit 216 outputs the decryption instruction and the encrypted data EDA (=Enc (KS, DA)) to the common key decryption unit 214.

When receiving the decrypted data DA′ from the common key decryption unit 214, the DEM ciphertext decryption unit 216 outputs the MAC instruction and the decrypted data DA′ to the MAC generation unit 212.

When receiving the MAC value HDA′ (=Hash (KH, DB′)), the DEM ciphertext decryption unit 216 compares HDA′ with HDA separated from the DEM ciphertext DEMA, and determines whether the MAC values HDA′ and HDA match each other.

When it is determined the MAC values HDA′ and HDA match each other, the DEM ciphertext decryption unit 216 outputs the decrypted data DA′, namely the encryption target data DA, to the outside via the IO unit 201.

When it is determined that the MAC values HDA′ and HDA do not match each other, the DEM ciphertext decryption unit 216 terminates the entire processing pertaining the encryption communication.

### (15) IO Unit 201

The IO unit 201 receives the encryption target data DB from the outside, and outputs the received encryption target data DB to the DEM ciphertext generation unit 215.

When receiving the decrypted data DA′ from the DEM ciphertext decryption unit 216, the IO unit 201 outputs the received decrypted data DA′ to the outside.

### (16) Transmitter and Recipient Unit 202

When receiving the KEM ciphertext KEMB from the KEM ciphertext generation unit 205, the transmitter and recipient unit 202 transmits the received KEM ciphertext KEMA to the encryption communication device A10 via the channel 30.

When receiving the KEM ciphertext KEMA from the encryption communication device A10 via the channel 30, the transmitter and recipient unit 202 outputs the received KEM ciphertext KEMA to the KEM ciphertext decryption unit 206.

When receiving the challenge data nB from the challenge data generation unit 209, the transmitter and recipient unit 202 transmits the received challenge data nB to the encryption communication device A10 via the channel 30.

When receiving the response data rB from the response data generation unit 210, the transmitter and recipient unit 202 transmits the received response data rB to the encryption communication device A10 via the channel 30.

When receiving the challenge data nA and the response data rA, alternatively solely the challenge data nA, from the encryption communication device A10 via the channel 30, the transmitter and recipient unit 202 outputs the challenge data nA and the response data rA, alternatively solely the challenge data nA, to the response data generation unit 210.

When receiving the response data rA from the encryption communication device A10, the transmitter and recipient unit 202 outputs the received response data rA to the response data verification unit 211.

When receiving the DEM ciphertext DEMB from the DEM ciphertext generation unit 215 via the channel 30, the transmitter and recipient unit 202 transmits the received DEM ciphertext DEMB to the encryption communication device A10 via the channel 30.

When receiving the DEM ciphertext DEMA from the encryption communication device A10 via the channel 30, the transmitter and recipient unit 202 outputs the received DEM ciphertext DEMA to the DEM ciphertext decryption unit 216.

### 1.4 Operation of Encryption Communication System 1

### (1) Operation Overview

The operation of the encryption communication system 1 is roughly composed of a key agreement phase where a key is shared between the encryption communication devices A10 and B20, a challenge and response authentication phase where mutual authentication is performed with use of the shared key, and a data encryption communication phase where data is transmitted and received with use of the shared key.

In the key agreement phase, the mutual authentication and the key distribution are performed between the encryption communication devices A10 and B20 using KEM. Thus, the key is shared between the devices.

In the challenge and response authentication phase, by performing the challenge and response authentication between the encryption communication devices A10 and B20 with use of the shared key, the encryption communication devices A10 and B20 verify each other whether an impersonation attack is made.

In the data encryption communication phase, encrypted data is transmitted between the encryption communication devices A10 and B20 via the channel 30.

Herein, the data is, for example, text data, music data, image data, and moving image content data.

### (2) Operation

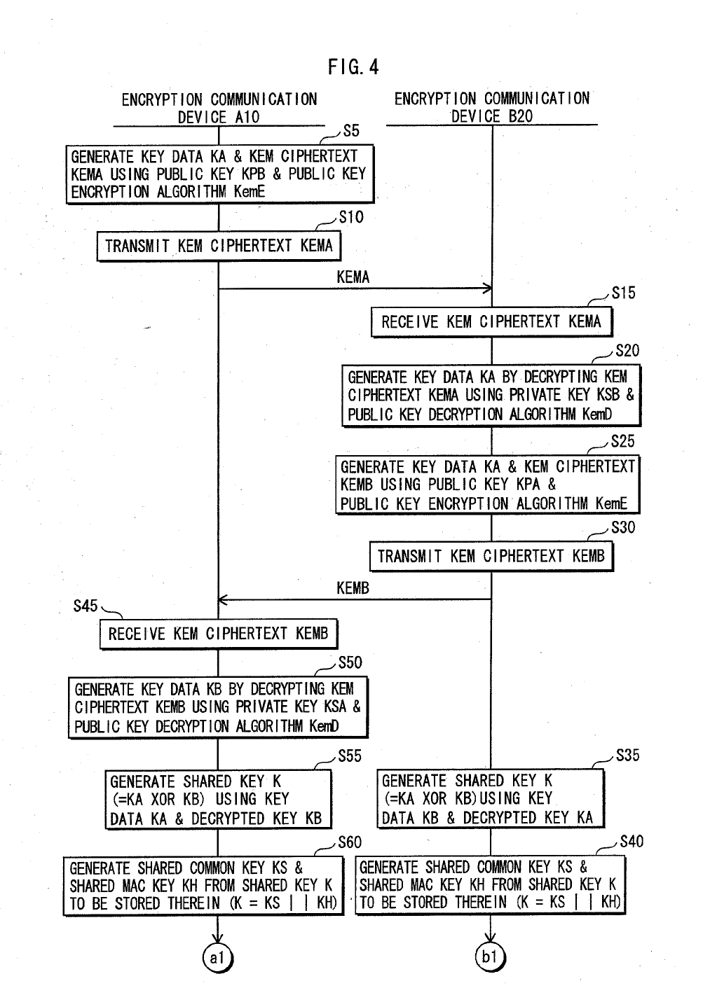

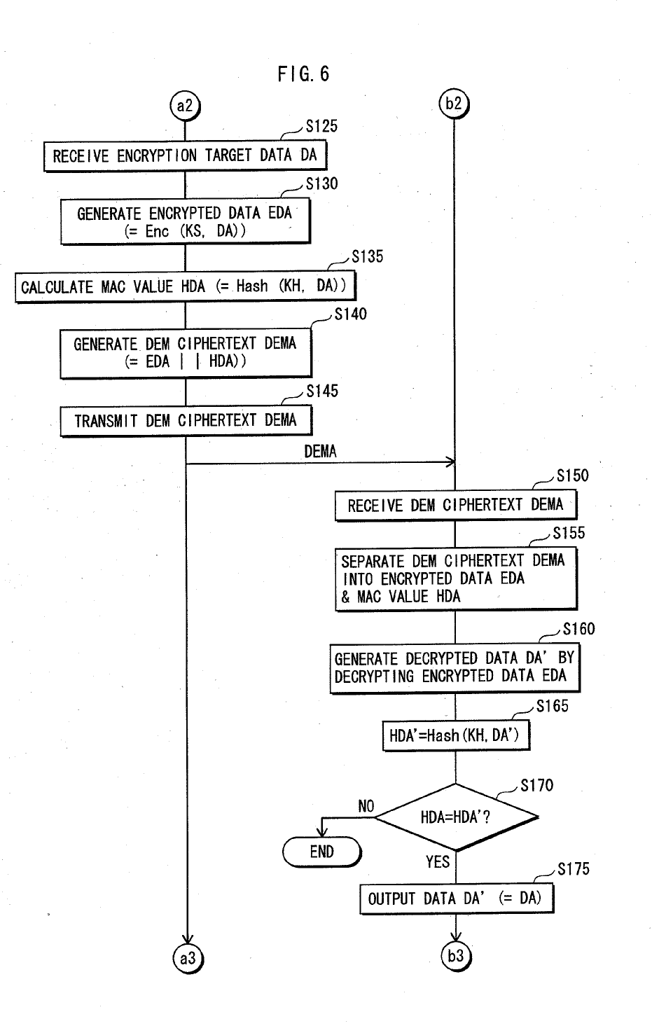

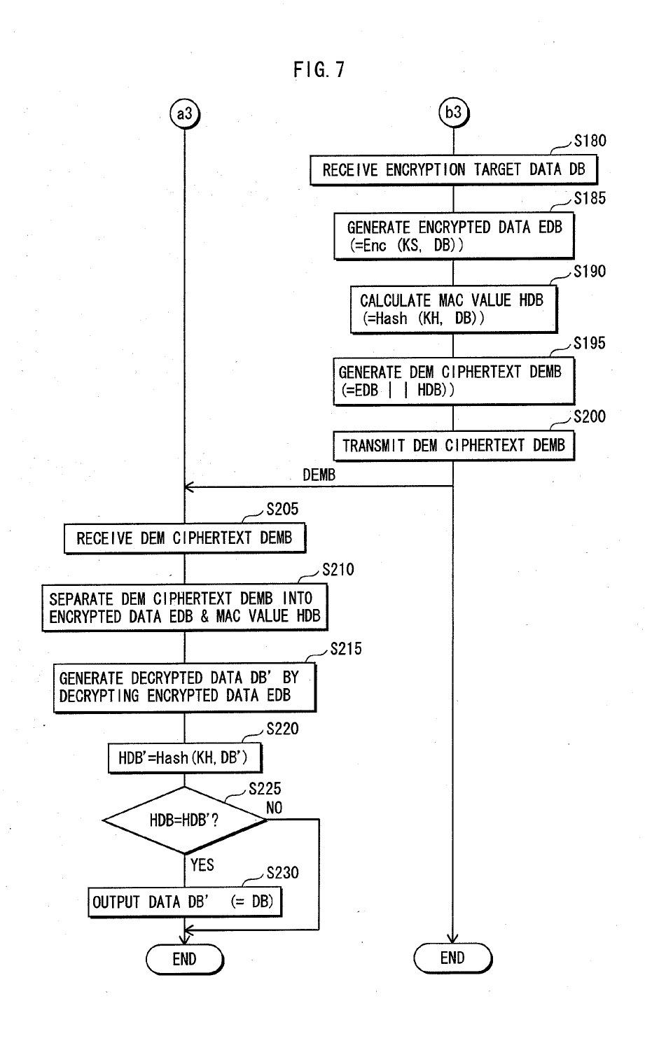

The following describes the operation of the encryption communication system 1, with use of the flow charts shown in FIGS. 4-7.

The KEM ciphertext generation unit 105 of the encryption communication device A10 generates the key data KA and the KEM ciphertext KEMA of the key data KA with use of the public key KPB and the public key encryption algorithm KemE of KEM (Step S5).

The KEM ciphertext generation unit 105 transmits the generated KEM ciphertext KEMA to the encryption communication device B20 (Step S10).

The KEM ciphertext decryption unit 206 of the encryption communication device B20 receives the KEM ciphertext KEMA from the encryption communication device A10 via the transmitter and recipient unit 202 (Step S15).

The KEM ciphertext decryption unit 206 decrypts the received KEM ciphertext KEMA with use of the public key decryption algorithm KemD corresponding to the public key encryption algorithm KemE and the private key KSB, thereby generating the key data KA (Step S20).

The KEM ciphertext generation unit 205 of the encryption communication device B20 generates the key data KB and the KEM ciphertext KEMB of the key data KB with use of the public key KPA and the public key encryption algorithm KemE of KEM (Step S25).

The KEM ciphertext generation unit 205 transmits the generated KEM ciphertext KEMB to the encryption communication device A10 (Step S30).

The shared key generation unit 207 of the encryption communication device B20 generates the shared key K (=KA xor KB) with use of the key data KB generated by the KEM ciphertext generation unit 205 and the key data KA generated by the KEM ciphertext decryption unit 206 (Step S35).

The shared key generation unit 207 generates the shared common key KS and the shared MAC key KH with use of the generated shared key K (K=KS∥KH), and the generated shared common key KS and shared MAC key KH are stored in the shared key storage unit 208 (Step S40).

The KEM ciphertext decryption unit 106 of the encryption communication device A10 receives the KEM ciphertext KEMB from the encryption communication device B20 via the transmitter and recipient unit 102 (Step S45).

The KEM ciphertext decryption unit 106 decrypts the received KEM ciphertext KEMB with use of the public key decryption algorithm KemD and the private key KSA, thereby generating the key data KB (Step S50).

The shared key generation unit 107 of the encryption communication device A10 generates the shared key K (=KA xor KB) with use of the key data KA generated by the KEM ciphertext generation unit 105 and the key data KB generated by the KEM ciphertext decryption unit 106 (Step S55).

The shared key generation unit 107 generates the shared common key KS and the shared MAC key KH with use of the shared key K (K=KS∥KH), and the generated shared common key KS and shared MAC key KH are stored in the shared key storage unit 108 (Step S60).

The challenge data generation unit 109 of the encryption communication device A10 generates the challenge data nA (Step S65), and transmits the generated challenge data nA to the encryption communication device B20 (Step S70).

The response data generation unit 210 of the encryption communication device B20 receives the challenge data nA from the encryption communication device A10 (Step S75).

The MAC generation unit 212 of the encryption communication device B20 calculates the MAC value HnA (=Hash (KH, nA)) of the challenge data nA with use of the shared MAC key KH stored in the shared key storage unit 208 and the pre-stored keyed hash function Hash. The calculated MAC value HnA is used as the response data rB (Step S80).

The challenge data generation unit 209 of the encryption communication device B20 generates the challenge data nB (Step S85).

The challenge data generation unit 209 and the response data generation unit 210 transmit the challenge data nB and the response data rB, respectively, to the encryption communication device A10 (Step S90).

The response data generation unit 110 of the encryption communication device A10 receives the challenge data nB and the response data rB from the encryption communication device B20 (Step S95).

The response data generation unit 110 outputs the response data rB and the verification instruction to the response data verification unit 111. When receiving the verification instruction and the response data rB from the response data generation unit 110, the response data verification unit 111 obtains the challenge data nA that is temporally stored in the challenge data generation unit 109. The response data verification unit 111 outputs the MAC generation instruction and the obtained challenge data nA to the MAC generation unit 112. The MAC generation unit 112 calculates the MAC value HnA of the challenge data nA with use of the shared MAC key KH stored in the shared key storage unit 108 and the keyed hash function Hash, and outputs the calculated MAC value HnA to the response data verification unit 111. When receiving the MAC value HnA from the MAC generation unit 112, the response data verification unit 111 determines whether the MAC value HnA and the response data rB match each other (Step S100).

When it is determined that the MAC value HnA and the response data rB do not match each other (“NO” in Step S100), the processing pertaining the encryption communication is terminated.

When it is determined that the MAC value HnA and the response data rB match each other (“YES” in Step S100), the response data verification unit 111 outputs the response data generation instruction to the response data generation unit 110. When receiving the response data generation instruction from the response data verification unit 111, the response data generation unit 110 outputs a MAC generation instruction and the temporally stored challenge data nB to the MAC generation unit 112. When receiving the MAC generation instruction and the challenge data nB from the response data verification unit 111, the MAC generation unit 112 calculates the MAC value HnB (=Hash (KH, nB)) of the challenge data nB with use of the shared MAC key KH stored in the shared key storage unit 208 and the keyed hash function Hash. The calculated MAC value HnB is used as the response data rA (Step S105).

The response data generation unit 110 transmits the response data rA to the encryption communication device B20 (Step S110).

The response data verification unit 211 of the encryption communication device B20 receives the response data rA from the encryption communication device A10 (Step S115).

The response data verification unit 211 obtains the challenge data nB temporally stored in the challenge data generation unit 209. The response data verification unit 211 outputs the MAC generation instruction and the obtained challenge data nB to the MAC generation unit 212. When receiving the MAC generation instruction and the challenge data nB from the response data verification unit 211, the MAC generation unit 212 calculates the MAC value HnB of the challenge data nB with use of the shared MAC key KH stored in the shared key storage unit 208 and the keyed hash function Hash, and outputs the calculated MAC value HnB to the response data verification unit 211. When receiving the MAC value HnB from the MAC generation unit 212, the response data verification unit 211 determines whether the MAC value HnB and the response data rA match each other (Step S120).

When it is determined that the MAC value HnB and the response data rA do not match each other (“NO” in Step S120), the processing pertaining the encryption communication is terminated.

When it is determined that the MAC value HnB and the response data rA match each other (“YES” in Step S120), the processing pertaining the encryption communication is continued.

The DEM ciphertext generation unit 115 of the encryption communication device A10 receives the encryption target data DA from the outside via the IO unit 101 (Step S125).

The common key encryption unit 113 of the encryption communication device A10 encrypts the encryption target data DA received by the DEM ciphertext generation unit 115 with use of the shared common key KS stored in the shared key storage unit 108 and the common key cryptosystem algorithm, thereby generating the encrypted data EDA (=Enc (KS, DA)) of the encryption target data DA (Step S130).

The MAC generation unit 112 of the encryption communication device A10 calculates the MAC value HDA (=Hash (KH, DA)) of the encryption target data DA received by the DEM ciphertext generation unit 115 with use of the shared MAC key KH stored in the shared key storage unit 108 and the keyed hash function Hash (Step S135).

The DEM ciphertext generation unit 115 concatenates the encrypted data EDA generated by the common key encryption unit 113 with the MAC value HDA calculated by the MAC generation unit 112, thereby generating the DEM ciphertext DEMA (=Enc (KS, DA)∥HDA) (Step S140).

The DEM ciphertext generation unit 115 transmits the generated DEM ciphertext DEMA to the encryption communication device B20 (Step S145).

The DEM ciphertext decryption unit 216 of the encryption communication device B20 receives the DEM ciphertext DEMA from the encryption communication device A10 (Step S150).

The DEM ciphertext decryption unit 216 separates the received DEM ciphertext DEMA into the encrypted data EDA and the MAC value HDA (Step S155).

The common key decryption unit 214 of the encryption communication device B20 decrypts the encrypted data EDA obtained by the DEM ciphertext decryption unit 216 with use of the shared common key KS stored in the shared key storage unit 208 and the common key decryption algorithm, thereby generating the decrypted data DA′ (Step S160).

The MAC generation unit 212 of the encryption communication device B20 calculates the MAC value HDA′ (=Hash (KH, DA′)) of the decrypted data DA′ generated by the common key decryption unit 214 with use of the shared MAC key KH stored in the shared key storage unit 208 and the keyed hash function Hash (Step S165).

The DEM ciphertext decryption unit 216 compares the MAC value HDA′ (=Hash (KH, DB′)) calculated by the MAC generation unit 212 and the MAC value HDA separated from the DEM ciphertext DEMA, and determines whether the MAC values HDA′ and HDA match each other (Step S170).

When it is determined that the MAC values HDA′ and HDA do not match each other (“NO” in Step S170), the processing pertaining encryption communication is terminated.

When it is determined that the MAC values HDA′ and HDA match each other (“YES” in Step S170), the DEM ciphertext decryption unit 216 outputs the decrypted data DA′, namely the encryption target data DA, to the outside via the IO unit 201 (Step S175).

The DEM ciphertext generation unit 215 of the encryption communication device B20 receives the encryption target data DB from the outside via the IO unit 201 (Step S180).

The common key encryption unit 213 of the encryption communication device B20 encrypts the encryption target data DB received by the DEM ciphertext generation unit 215 with use of the shared common key KS stored in the shared key storage unit 208 and the common key cryptosystem algorithm, thereby generating the encrypted data EDB (=Enc (KS, DA)) of the encryption target data DB (Step S185).

The MAC generation unit 212 of the encryption communication device B20 calculates the MAC value HDB (=Hash (KH, DB)) of the encryption target data DB received by the DEM ciphertext generation unit 215 with use of the shared MAC key KH stored in the shared key storage unit 208 and the keyed hash function Hash (Step S190).

The DEM ciphertext generation unit 215 concatenates the encrypted data EDB generated by the common key encryption unit 213 with the MAC value HDB calculated by the MAC generation unit 212, thereby generating the DEM ciphertext DEMB (=Enc (KS, DB)∥HDB) (Step S195).

The DEM ciphertext generation unit 215 transmits the generated DEM ciphertext DEMB to the encryption communication device A10 (Step S200).

The DEM ciphertext decryption unit 116 of the encryption communication device A10 receives the DEM ciphertext DEMB from the encryption communication device B20 (Step S205).

The DEM ciphertext decryption unit 116 separates the received DEM ciphertext DEMB (=EDB∥HDB) into the encrypted data EDB and the MAC value HDB (Step S210).

The common key decryption unit 114 of the encryption communication device A10 decrypts the encrypted data EDB obtained by the DEM ciphertext decryption unit 116 with use of the shared common key KS stored in the shared key storage unit 108 and the common key decryption algorithm, thereby generating the decrypted data DB′ (Step S215).

The MAC generation unit 112 of the encryption communication device A10 calculates the MAC value HDB′ (=Hash (KH, DB′)) of the decrypted data DB′ generated by the common key decryption unit 114 with use of the shared MAC key KH stored in the common key storage unit 108 and the keyed hash function Hash (Step S220).

The DEM ciphertext decryption unit 116 compares the MAC value HDB′ calculated by the MAC generation unit 112 and the MAC value HDB separated from the DEM ciphertext DEMB, and determines whether the MAC values HDB′ and HDB match each other (Step S225).

When it is determined that the MAC values HDB′ and HDB do not match each other (“NO” in Step S225), the processing pertaining the encryption communication is terminated.

When it is determined that the MAC values HDB′ and HDB match each other (“YES” in Step S230), the DEM ciphertext decryption unit 116 outputs the decrypted data DB′, namely the encryption target data DB, to the outside via the IO unit 101 (Step S230).

Herein, the key agreement phase corresponds the processing from Steps S5 to S60, the challenge and response authentication phase corresponds to the processing from Steps S65 to S120, the data encryption communication phase to the processing from Steps S125 to S230.

### 1.5 Effect of Embodiment 1

Embodiment 1 ensures not only the resistance to the leakage of the shared key but also the security against the impersonation attack, by adding the processing of the challenge and response authentication with use of the shared MAC key to the key encapsulation mechanism (KEM) and to the transmission of the DEM ciphertext.

The following is a detailed description of the above.

As long as a scheme concerns data transmission of encrypted data and the keyed hash function value of the encrypted data with use of the key shared by the key encapsulation mechanism, as the data encryption scheme, it is guaranteed that the scheme can prove the security against leakage of the shared key and leakage of plaintext data corresponding to ciphertext data based on a difficult math problem.

Note that since this is described in “A proposal for an ISO standard for public key encryption (version 2.1)” written by Victor Shoup, the description is omitted here.

Similarly, since the present scheme employs data transmission of the encrypted data and the keyed hash value of the encrypted data with the use of the key shared by the key encapsulation mechanism, similarly the security can be guaranteed.

If the encryption communication device A10 does not have the valid private key KSA, since the key data KB cannot be obtained by decrypting the KEM ciphertext KEMB, the shared common key KS and the shared MAC key KH that are shared with the encryption communication device B20 cannot be obtained. Thus, the encrypted data EDB cannot be decrypted in Step S215. In addition, similarly, if the encryption communication device B20 does not have the valid private key KSB, the key data KA cannot be obtained by decrypting the KEM ciphertext KEMA. Therefore, the shared common key KS and the shared MAC key KH that are shared with the encryption communication device A10 cannot be obtained. For that reason, the encrypted data EDA cannot be decrypted in Step S160. The valid private keys KSA and KSB are required to obtain the valid key data KA and KB.

Accordingly, mutual authentication between the devices is realized by mutual communication of the KEM ciphertexts KEMB and KEMA between the devices.

Furthermore, in Embodiment 1, the challenge and response authentication with use of the shared MAC key KH is performed. In order to determine the validity of the encryption communication device, it is necessary to transmit the valid response data. In Embodiment 1, the MAC generation unit used by the DEM ciphertext generation unit is used to generate the response data. Unless the shared MAC key KH is known to the MAC generation unit, it is very unlikely that the MAC generation unit used in the DEM ciphertext generation unit generates the valid response data.

Accordingly, the valid response data can be generated, which is to say, an impersonation attack can be made with the authentication being slipped through, which means that the attacker knows the shared MAC key KH. However, since the difficulty in leakage of not only the shared MAC key KH but also each shared key generated with use of KEM (security against leakage of shared key) can be proved, the difficulty in the impersonation attack can be proved.

Thus, the authentication key agreement that guarantees the security against not only the key leakage or plaintext leakage but also impersonation attacks can be realized, which is very valuable.

### 1.6 Modification of Encryption Communication System 1

In the above embodiment, the two encryption communication devices are used in the encryption communication system 1, to which the present invention is not limited.

The encryption communication system in accordance with the present invention may be composed of two programs that perform encryption communication when data is transmitted and received (input and output) between a tamper resistant area A and another area B. These two programs are executed by a computer device, and the encryption communication of the present invention is performed between the two executed programs.

Herein, the two programs that perform the encryption communication are referred to as a program A and a program B. The program A is stored in the area A and the program B is stored in the area B.

The program A and the program B each include an IO step, a transmission and reception step, a KEM ciphertext generation step, a KEM ciphertext decryption step, a shared key generation step, a challenge data generation step, a response data generation step, a response data verification step, a MAC generation step, a common key encryption step, a shared key decryption step, a DEM ciphertext generation step, and a DEM ciphertext decryption step.

As with the aforementioned encryption communication device, the areas A and B each include a public key storage unit that stores a public key of its communication target therein and a private key storage unit that stores its own private key therein, and a shared key storage unit that has an area to store the shared common key KS and the shared MAC key KH. Herein, a content of each storage unit in the area A is not leaked to the outside because of the tamper resistance of the area A. The content of each storage unit in the area B is not leaked the outside either (e.g. tamper resistance).

When each step performs operations similarly to the component showed in the above embodiment, as with the above, the key agreement phase, the challenge and response authentication phase, and the data encryption communication phase are realized. Accordingly, the description of the operation of each step is omitted.

Although the present invention is applied to the encryption communication between the two programs, note that the present invention is not limited to this.

The present invention may be applied to the encryption communication between the encryption communication device and the program. More specifically, the present invention may be applied to the encryption communication when the encryption communication device is a DVD device and when the program is recorded on a DVD. Note that the program is executed by an execution unit of the DVD device, and the encryption communication of the present invention is performed between a component (e.g. a similar component to the encryption communication device A10) set in the DVD device and the executed program.

### 1.7 Other Modification

The abovementioned embodiments are merely examples of the embodiments of the present invention. The present invention is, by no means, limited to the above embodiments, and can be embodied in various forms within a scope not departing from the object. Cases such as follows are included in the present invention.

(1) In the above embodiment, data is transmitted and received between the encryption communication devices A10 and B20, to which the present invention is not limited.

Only one encryption communication device (e.g. encryption communication device A10) may perform data transmission, and only another encryption communication device (e.g. encryption communication device B20) may perform data reception.

(2) In the above embodiment, some other processing, such as verification processing of device functions (music listening function, movie viewing function, broadcast reception function and etc.) may be included between the key agreement phase and the challenge and response authentication phase or between the challenge and response authentication phase and the data encryption communication phase. In addition, the present invention is not limited the order of the processing step within the each phase shown in the above embodiments.

(3) In the above embodiment, in the challenge and response authentication phase, each encryption communication device transmits the challenge data generated at random to its communication target, to which the present invention is not limited.

Each encryption communication device may use the challenge data as key data (key data KB for the encryption communication device A10, key data KA for the encryption communication device B20) that can be obtained from the KEM ciphertext of its communication target.

Thus, the processing of the transmission of the challenge data can be reduced. Then, the communication target can perform a similar authentication to that of the challenge and response authentication phase by verifying whether or not the key data generated by its own device and the key data transmitted as the challenge data match each other.

For example, when receiving the challenge data rB (=Hash (KH, KA)) from the encryption communication device B20, the encryption communication device A10 calculates a MAC value of KA generated by itself, and performs authentication of the communication target by determining whether the calculated MAC value and the challenge data rB match each other.

In addition, when receiving the challenge data rA (=Hash (KH, KB)) from the encryption communication device A10, the encryption communication device B20 calculates a MAC value of KB generated by itself, and performs authentication of the communication target by determining whether the calculated MAC value and the challenge data rA match each other.

(4) In the above embodiment, the shared key generation unit of each encryption communication device generates the shared key K, and a part of the generated shared key K is used as the shared common key KS and other part of the shared key K is used as the shared MAC key KH, to which the present invention is not limited.

The shared key generation unit of each encryption communication device may use the entirety of the shared key K as the shared common key KS, and the entirety of the shared key K as the shared MAC key KH. That is to say, K=KS=KH.

(5) In the above embodiment, the shared key generation unit of each encryption communication device generates the shared key K with use of the XOR of the keys KA and KB, to which the present invention is not limited.

The shared key generation unit may generate the shared key K with use of the hash function Hash used by the MAC generation unit.

For example, the shared key generation unit of each encryption communication device may use Hash (KA, KB) or Hash (KB, KA) as the shared key K.

In addition, when the hash function Hash is SHA1 as shown in the above embodiment, the shared key generation unit of each encryption communication device may use SHA1 (KA∥KB) as the shared key K, or SHA1 (KB∥KA) as the shared key K.

Thus, the security in generating the shared key is improved.

(6) In the above embodiment, each encryption communication device pre-stores the public key of its communication target in the public key storage unit, to which the present invention is not limited.

The encryption communication device may transmit the public key certificate issued by a certificate center (including the public key itself and a signature of the certificate center of the public key) to its communication target. For example, the encryption communication device A10 receives a public key certificate of the public key KPB from its communication target which is the encryption communication device B20. The encryption communication device B20 receives a public key certificate of the public key KPA from its communication target which is the encryption communication device A10.

In such a case, each encryption communication device that is the communication target has a public key issued by the certificate center. Before the key agreement phase, both encryption communication devices verify each other's public key certificate with use of the public key issued by the certificate center. When it is determined that the certificate is valid, the public key contained in the public key certificate is stored in the public key storage unit.

In addition, each encryption communication device may receive the public key certificate from the certificate center.

(7) In the above embodiment, the method to calculate the keyed hash value is used for the challenge and response authentication, to which the present invention is not limited.

For example, the response data generated by encrypting the challenge data with the shared MAC key KH may be communicated.

In this verification, a result obtained by decrypting the response data and the challenge data owned by the transmitting source may be compared. Alternatively, a result obtained by encrypting the challenge data owned by the transmitting source in the same way and the response data may be compared.

In addition, the authentication method is not limited to the challenge and response authentication. As long as the key data shared by KEM can act on the authentication result, any authentication method is applicable.

Also, the challenge and response authentication is not limited to the above-mentioned authentication method. The challenge and response authentication that is different from the above-mentioned method is also applicable.

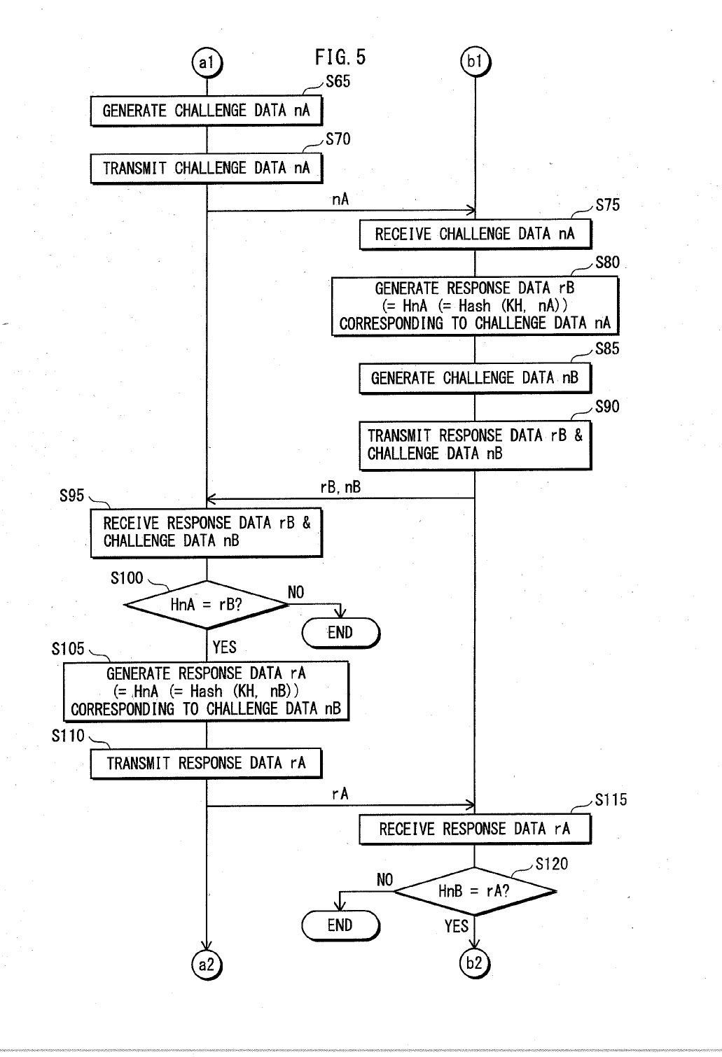

The following describes an example of such a method. Note that the description is mainly made on modifications of Steps S65-S100 shown in FIG. 5 regarding when the encryption communication device A10 authenticates the encryption communication device B20.

After the execution of Step S65, the encryption communication device A10 encrypts the generated challenge data nA with use of the shared MAC key KH owned by itself, thereby generating the encrypted data Enc (KH, nA).

In Step S70, the encryption communication device A10 transmits the generated encrypted data Enc (KH, nA) to the encryption communication device B20.

In Step S75, the encryption communication device B20 receives the encrypted data Enc (KH, nA).

In Step S80, the encryption communication device B20 decrypts the received encrypted data Enc (KH, nA) with use of the shared MAC key KH owned by itself, thereby generating the decrypted data nA′. The generated decrypted data nA′ is used as the response data rB (=nA′).

The encryption communication device B20 executes Steps S85 and S90.

After the execution of Step S95, the encryption communication device A10 compares the received response data and the challenge data nA stored therein and determine the validity of the encryption communication device B20.

Note that in Step S85, the encryption communication device B20 may generate the encrypted data Enc (KH, nB) by encrypting the generated challenge data nB with use of the shared MAC key KH owned by itself. Then, the encryption communication device A10 decrypts the received encrypted data Enc (KH, nB) with use of its own shared MAC key KH, thereby generating the decrypted data nB′. The generated decrypted data nB′ is used as the response data rA (=nB′).

(8) In the above embodiment, the challenge and response authentication is bilaterally performed, to which the present invention is not limited.

One-way challenge and response authentication is also applicable. In that case as well, the security against the impersonation attack made by an authenticatee can be proved.

Note that, in this case, the shared MAC key KH does not need to be generated, and the authentication may be performed directly using the key data KA and the key data KB. That is to say, due to the one-way authentication, if a recipient of the KEM ciphertext has the valid public key, since the recipient can obtain the key data KA or the key data KB, the authentication may be performed with use of the obtained key data.

In this case, for example, when the key data KA is shared, one-way authentication from the encryption communication device B20 to the encryption communication device A10 enables the simple mutual authentication. That is to say, since the key data is shared, it can be verified if the encryption communication device B20 has the valid private key KSB. Thus, it can be verified that the encryption communication device B20 is valid. Subsequently, since the challenge and response authentication enables the verification of whether the encryption communication device A10 with which the key data KA is shared, the validity of the encryption communication device A10 can be verified.

In addition, after generating the shared MAC key KH, one-way authentication may be performed with use of the shared MAC key KH. Furthermore, also in the above case, needless to say, the one-way authentication from the encryption communication device A10 to the encryption communication device B20 may be performed.

(9) In the above embodiment, the encryption communication device B20 may be a memory card having an IC function.

Since the IC memory card can be realized by the same components as the encryption communication device B20, herein the description of the structure of the IC memory card is omitted.

Note that according to the present invention, the IC memory card is contained in the concept of the encryption communication device. That is to say, the present invention is applicable to the encryption communication between two IC memory cards, or between the encryption communication device A10 and the IC memory card.

(10) In the above embodiment, the common key generation units 107 and 207 obtain the shared common key KS and the shared MAC key KH to satisfy K=KS∥KH with regard to the shared key data K, to which the present invention is not limited.

The shared key generation units 107 and the 207 may obtain the shared common key KS and the shared MAC key KH to satisfy K=KH∥KS with regard to the shared key data K.

For example, two values that can be obtained by separate conversions of the shared key data K may be the shared common key KS and the shared MAC key KH.

That is to say, any value of the shared common key KS and the shared MAC key KH are applicable as long as the values are determined in accordance with the shared key data K.

(11) In the above embodiment, the encryption communication device B20 transmits the response data rB together with the challenge data nB to the encryption communication device A10, to which the present invention is not limited.

The response data rB and the challenge data nB may be transmitted to the encryption communication device A10 at a different timing. In this case, the encryption communication device A10 may receive the response data rB and the challenge data nB at a different timing.

(12) In concrete terms, each of the above devices is a computer system composed of a microprocessor, a ROM, a RAM, a hard disk unit, a display unit, a keyboard, a mouse and such. The RAM and the hard disk unit are stored in a computer program. Each device achieves its function by the operation of the microprocessor according to the computer program. Herein, the computer program is composed of a combination of a plurality of instruction codes that issue instructions to instruct the computer to achieve designated functions.

(13) Components of each of the above devices may be partially or entirely made of one system LSI (Large Scale Integration). The system LSI is a super multifunctional LSI manufactured by integrating a plurality of components on one chip. More specifically, the system LSI is a computer system including a microprocessor, a ROM, a RAM and such. The RAM has a computer program stored therein. The system LSI achieves its function by the microprocessor that operates according to the computer program.

In addition, each unit of the components composing the above device unit may be individually integrated on one chip. Alternatively, the units are partially or entirely integrated on one chip.

Herein, the system LSI is employed. However, according to the integration degree, the system may be called IC, LSI, super LSI, or ultra LSI. The integrated-circuit method is not limited to the LSI, and may be realized by a dedicated communication circuit and a general-purpose processor. After the LSI manufacture, FPGA (Field Programmable Gate Array) that is programmable and reconfigurable processor that can reconfigure a concatenation and a setting of a circuit cell inside LSI is applicable.

Moreover, when progress or derivation from semiconductor technology gives rise to a new technology of circuit integration that replaces LSI, as a matter of course, function blocks may be integrated with use of the new technology, which can be potentially applied to the biotechnology and such.

(14) Components of each of the above devices may be partially or entirely made of an IC card detachable to each device, or a single module. The IC card and the module are each a computer system composed of a microprocessor, a ROM, a RAM and such. The IC card and the module may each include the above super multifunctional LSI. The IC card and the module each achieve its function by the operation of the microprocessor according to a computer program. This IC card or the module may be tamper resistant.

(15) The present invention may be the methods described as above. Also, the present invention may be a computer program that causes a computer to realize these methods. Also, the present invention may be a digital signal composed of the computer program.

(16) In addition, the present invention may be the computer program or the digital signal stored on a computer readable recording medium, such as a flexible disk, a hard disk, a CD-ROM, an MO, a DVD, a DVD-ROM, a DVD-RAM, a BD (Blu-ray Disc), and a semiconductor memory. Also, the present invention may be the digital signal stored on these recording media.

(17) In addition, the present invention may transmit the computer program or the digital signal via an electric communication line, a wireless or wired communication line, network which is notably Internet, digital broadcasting and such.

(18) In addition, the present invention may be a computer system provided with a microprocessor and a memory. The memory stores the computer program therein. The microprocessor may perform operation according to the computer program.

(19) The present invention may be realized by another independent computer system as follows. The program or the digital signal recorded on the recording medium is transmitted. Alternatively, the program or the digital signal is transmitted via the network.

(20) The present invention may be any combination of the above embodiments and modifications.

### 1.8 Conclusion

(1) The present invention is an encryption communication system characterized as follows. The first encryption communication device and the second encryption communication device are provided in the system. A key is distributed between the first and second encryption communication devices. With use of the shared key, the content data is transmitted from the first encryption communication device to the second encryption communication device. The first encryption communication device includes an IO unit that receives input of the content data, a first transmitter and recipient unit that transmits and receives data to and from the second encryption communication device data, a first key ciphertext generation unit that generates a first key and a first key ciphertext by encrypting the first key, a first key ciphertext decryption unit that generates a first decrypted key by decrypting a second key ciphertext, a first shared key generation unit that generates a first shared key based on the first key and the first decrypted key, a first shared key storage unit that stores therein the first shared key, a first challenge data generation unit that generates first challenge data, a first response data generation unit that generates first response data corresponding to second challenge data, a first response data verification unit that verifies second response data, a data ciphertext generation unit that generates encrypted content data by encrypting the content data. The second encryption communication device includes an IO unit that outputs decrypted content data, a second transmitter and recipient unit that transmits and receives data to and from the first encryption communication device, a second key ciphertext generation unit that generates a second key and a second key ciphertext by encrypting the second key, a second key ciphertext decryption unit that generates a second decrypted key by decrypting the first key ciphertext, a second shared key generation unit that generates a second shared key based on the second key and the second decrypted key, a second shared key storage unit that stores therein the second shared key, a second challenge data generation unit that generates the second challenge data, a second response data generation unit that generates the second response data corresponding to the first challenge data, a second response data verification unit that verifies the first response data, and a data ciphertext decryption unit that generates the decrypted content data by decrypting the encrypted content data. The first response data generation unit generates a keyed hash value whose key comprises the entirety or part of the first shared key with use of the keyed hash function for the response data, and uses the keyed hash value as the first response data. The first response data verification unit generates the keyed hash value whose key comprises the entirety or part of the first shared key with use of the keyed function for the response data, and uses the keyed hash value for the verification of the second response data. The data ciphertext generation unit generates the keyed hash value whose key comprises the entirety or part of the first shared key with use of a keyed hash function for the data ciphertext. The second response data generation unit generates the keyed hash value whose key comprises the entirety or part of the second shared key with use of the keyed hash function for the response data, and uses the keyed hash value as the second response data. The second response data verification unit generates the keyed hash value whose key comprises the entirety or part of the second shared key with use of the keyed hash function for the response data, and uses the keyed hash value for the verification of the first response data. The data ciphertext decryption unit generates the keyed hash value whose key comprises the entirety or part of the second shared key with use of the keyed hash function for the data ciphertext.

(2) In the aforementioned (1), the keyed hash function for the response data may be identical with the keyed hash function for the data ciphertext.

(3) In the aforementioned (1), the first key ciphertext and the second key ciphertext may be generated with use of the key encapsulation mechanism.

(4) In any of the aforementioned (1)-(3), the first key generation unit may output the XOR of the first key and the first decrypted key as the first shared key, and the second key generation unit may output the XOR of the second key and the second decrypted key as the second shared key.

(5) In any of the aforementioned (1)-(3), the first shared key generation unit may output a hash value calculated with use of the shared key generation hash function as the first shared key to the concatenation of bits of the first key and the first decrypted key. In addition, the second shared key generation unit may output a hash value calculated with use of the shared key generation hash function as the second shared key to the concatenation of bits of the second key with the second decrypted key.

(6) In the aforementioned (5), the keyed hash function for the response data and the keyed hash function for the data ciphertext may be based on the shared key generation hash function.

(7) In any of the aforementioned (1)-(6), the first encryption communication device may not have the first challenge data generation unit and may use the first challenge data as the first key. Also, the second encryption communication device may not have the second challenge data generation unit and may use the second challenge data as the second key.

(8) The present invention is a content transmitter device in an encryption communication system characterized as follows. The content transmitter device and a content recipient device are provided in the system. A key is distributed between the content transmitter device and the content recipient device. With use of the shared key, encryption communication is performed in the encryption communication system. The content transmitter device includes an input unit that receives input of the content data, a transmitter and recipient unit that transmits and receives the data to and from the content recipient device, a first key ciphertext generation unit that generates a first key and a first key ciphertext by encrypting the first key, a first key ciphertext decryption unit that generates a first decrypted key by decrypting a second key ciphertext transmitted from the content recipient device, a shared key generation unit that generates a first shared key based on the first key and the first decrypted key, a shared key storage unit that stores therein the first shared key, a challenge data generation unit that generates first challenge data, a response data generation unit that generates first response data corresponding to the second challenge data transmitted from the content recipient device, a response data verification unit that verifies the second response data transmitted from the content recipient device, a data ciphertext generation unit that generates encrypted content data by encrypting the content data. The response data generation unit generates a keyed hash value whose key comprises the entirety or part of the first shared key with use of the keyed hash function for the response data, and uses the keyed hash value as the first response data. The response data verification unit generates the keyed hash value whose key comprises the entirety or part of the first shared key with use of the keyed hash function for the response data, and uses the keyed hash value for the verification of the response data. The data ciphertext generation unit generates the keyed hash value whose key comprises the entirety or part of the first shared key with use of the keyed hash function for the data ciphertext.

(9) In the aforementioned (8), the first key ciphertext and the second key ciphertext may be generated with use of the key encapsulation mechanism.

(10) In the aforementioned (9), the keyed hash function for the response data and the keyed hash function for the data ciphertext may be based on the shared key generation hash function.

(11) The present invention is a content recipient device in an encryption communication system characterized as follows. A content transmitter device and the content recipient device are provided in the system. The key is distributed between the content transmitter device and the content recipient device. With use of the shared key, encryption communication is performed in the encryption communication system. The content recipient device includes an output unit that outputs decrypted content data, a transmitter and recipient unit that transmits and receives data to and from the content transmitter device, a second key ciphertext generation unit that generates a second key and a second key ciphertext generated by encrypting the second key, a second key ciphertext decryption unit that generates a second decrypted key by decrypting a first key ciphertext transmitted from the content transmitter device, a shared key generation unit that generates a second shared key based on the second key and the second decrypted key, a shared key storage unit that stores therein the second shared key, a challenge data generation unit that generates second challenge data, a response data generation unit that generates the second response data corresponding to first challenge data transmitted from the content transmitter device, a response data verification unit that verifies the first response data transmitted from the content transmitter device, a data ciphertext decryption unit that generates the decrypted content data by decrypting encrypted data transmitted from the content transmitter device. The response data generation unit generates a keyed hash value whose key comprises the entirety or part of the second shared key with use of the keyed hash function for the response data, and uses the keyed hash value as the second response data. The response data verification unit generates the keyed hash value whose key comprises the entirety or part of the second shared key with use of the keyed function for the response data, and uses the keyed hash value for the verification of the first response data. The data ciphertext decryption unit generates the keyed hash value whose key comprises the entirety or part of the second shared key with use of the keyed hash function for the data ciphertext.

(12) In the abovementioned (11), the first key ciphertext and the second key ciphertext may be generated with use of the key encapsulation mechanism.

(13) In either of the abovementioned (11) and (12), the keyed hash function for the response data and the keyed hash function for the data ciphertext may be based on the shared key generation hash function.

(14) With these configurations, adding the challenge and response authentication with use of the shared key after the key agreement with use of the key encapsulation mechanism ensures the security against impersonation attacks, which is highly valuable.

### INDUSTRIAL APPLICABILITY

Each device, each method and the computer program that constitutes the present invention can be, continuously and repeatedly used in any industries required to handle information in safety and with certainty for business.

In addition, each device, each method and the computer program that constitutes the present invention can be continuously and repeatedly manufactured and sold in electronic manufacturing industries for business.

1-20. (canceled)

21. A communication device that secretly communicates, with a valid external device, target data using a key shared with the valid external device, the communication device comprising:
a key generation unit operable to generate a key using, in conjunction with an external device, a scheme of which security is proved, the key being shared with the external device if the external device is valid;
a determination unit operable to determine whether the external device is valid by performing authentication with use of a key dependent function depending on the key and being shared with the valid external device; and
a data generation unit operable, if the determination unit determines that the external device is valid, to generate verification data from target data with use of the key dependent function for secretly communicating the target data, the verification data being for verifying validity of the target data.

22. The communication device of claim 21, wherein
the key generation unit (i) generates first key data,
(ii) shares, with the external device, the first key data and second key data generated by the external device by secretly transmitting the first key data to the external device and secretly receiving the second key data from the external device, and (iii) generates the key with use of the first key data and the second key data.

23. The communication device of claim 22, wherein
the authentication is challenge and response authentication, and
the determination unit receives response data from the external device and performs the challenge and response authentication using the response data and challenge data, the response data being generated by applying the key dependent function to the challenge data and the key, and the challenge data being identical with the first key data.

24. The communication device of claim 22, wherein
the key generation unit calculates key data by performing an EXCLUSIVE-OR operation of the first key data and the second key data, and generates the key from the calculated key data.

25. The communication device of claim 24, wherein
the key generation unit uses part of the calculated key data as the key.

26. The communication device of claim 24, wherein
the key generation unit uses an entirety of the calculated key data as the key.

27. The communication device of claim 22, wherein
the key generation unit generates key data by applying the key dependent function to the first key data and the second key data, and generates the key from the calculated key data.

28. The communication device of claim 21, wherein
the key dependent function is a one-way function dependent on the key.

29. The communication device of claim 22, wherein
the key is a verification key used for the authentication of the external device and the generation of the verification data,
the key generation unit further generates an encryption key from the first key data and the second key data, the encryption key being shared with the external device if the external device is valid and being used for encryption and decryption of the target data, and
the communication device further comprises a transmission unit operable to encrypt the target data with use of the encryption key to generate encrypted data, and to transmit the encrypted data and the verification data to the external device.

30. The communication device of claim 22, wherein
the key is a verification key used for the authentication of the external device and the generation of the verification data,
the key generation unit further generates an encryption key from the first key data and the second key data, the encryption key being shared with the external device if the external device is valid and being used for encryption and decryption of the target data,
the communication device further comprises a recipient unit operable to receive encrypted data from the external device, the encrypted data being the target data encrypted with use of the encryption key, and
the data generation unit decrypts the received encrypted data to generate decrypted data, and generates verification data using the decrypted data as the target data.

31. The communication device of claim 21, wherein
the key generation unit generates the key with use of a key encapsulation mechanism to distribute the key.

32. A communication device that secretly communicates, with a valid running program, target data using a key shared with the valid program, the communication device comprising:
a key generation unit operable to generate a key using, in conjunction with an external device, a scheme of which security is proved, the key being shared with the external device if the external device is valid;
a determination unit operable to determine whether the program is valid by performing authentication with use of a key dependent function depending on the key and being shared with the valid program; and
a data generation unit operable, if the determination unit determines that the program is valid, to generate verification data from the target data with use of the key dependent function for secretly communicating the target data, the verification data being for verifying validity of the target data.

33. A program that causes a computer device to secretly communicate, with the program that is valid, target data using a key shared with the valid program, the program comprising program code operable to cause the computer device to execute the steps of:
generating a key using, in conjunction with the computer device, a scheme of which security is proved, the key being shared with the computer device if the program is valid;
determining whether the program is valid by performing authentication with use of a key dependent function depending on the key and being shared with the computer device; and
if the determination unit determines that the computer device is valid, generating verification data from target data with use of the key dependent function for secretly communicating the target data, the verification data being for verifying validity of the target data.

34. A first program stored in a first area that causes a computer device to secretly communicate, with a valid second program stored in a second area, target data using a key shared with the valid second program, the first program and the second program each being executed by the computer device, the first program comprising program code operable to cause the computer device to execute the steps of:
generating a key using, in conjunction with the second program, a scheme of which security is proved, the key being shared with the second program if the second program is valid
determining whether the second program is valid by performing authentication with use of a key dependent function depending on the key and being shared with the second program; and
if the second program is determined to be valid, generating verification data from target data with use of the key dependent function for secretly communicating the target data, the verification data being for verifying validity of the target data.

35. A communication system having a first communication device and a second communication device that secretly communicate target data using a key shared with each other if the first communication device and the second communication device are valid with each other, wherein
the first communication device comprises:
a first key generation unit operable to generate a first key using, in conjunction with the second communication device, a scheme of which security is proved, the first key being shared with the second communication device if the second communication device is valid;
a first determination unit operable to determine whether the second communication device is valid by performing authentication with use of a key dependent function depending on the first key and being shared with the valid second communication device; and
a first data generation unit operable, if the first determination unit determines that the second communication device is valid, to generate first verification data from target data with use of the key dependent function for secretly communicating the target data, the first verification data being for verifying validity of the target data, and
the second communication device transmits authentication data to the first communication device, the authentication data being used by the first device to perform the authentication of the second communication device.

36. The communication system of claim 35, wherein
the second communication device comprises:
a second key generation unit operable to generate a second key using, in conjunction with the first communication device, a scheme of which security is proved, the second key being shared with the first communication device if the first communication device is valid;
a second determination unit operable to determine whether the first communication device is valid by performing authentication with use of the key dependent function; and
a second data generation unit operable, if the determination unit determines that the first communication device is valid, to generate second verification data from target data with use of the key dependent function for secretly communicating the target data, the second verification data being for verifying validity of the target data, and
the first communication device transmits authentication data to the first communication device, the authentication data being used by the second device to perform the authentication of the first communication device.

37. A communication method used by a communication device that secretly communicates, with a valid external device, target data using a key shared with the valid external device, the communication method comprising the steps of:
generating a key using, in conjunction with an external device, a scheme of which security is proved, the key being shared with the external device if the external device is valid;
determining whether the external device is valid by performing authentication with use of a key dependent function depending on the key and being shared with the valid external device; and
if the determination unit determines that the external device is valid, generating verification data from target data with use of the key dependent function for secretly communicating the target data, the verification data being for verifying validity of the target data.

38. A communication program that causes a communication device to secretly communicate, with a valid external device, target data using a key shared with the valid external device, the communication program comprising program code operable to cause the communication device to execute the steps of:
generating a key using, in conjunction with an external device, a scheme of which security is proved, the key being shared with the external device if the external device is valid;
determining whether the external device is valid by performing authentication with use of a key dependent function depending on the key and being shared with the valid external device; and
if the determination unit determines that the external device is valid, generating verification data from target data with use of the key dependent function for secretly communicating the target data, the verification data being for verifying validity of the target data.

39. The communication program of claim 38 being stored on a computer readable recording medium.

40. An integrated circuit of a communication device that secretly communicates, with a valid external device, target data using a key shared with the valid external device, the integrated circuit comprising:
a key generation unit operable to generate a key using, in conjunction with an external device, a scheme of which security is proved, the key being shared with the external device if the external device is valid;
a determination unit operable to determine whether the external device is valid by performing authentication with use of a key dependent function depending on the key and being shared with the valid external device; and
a data generation unit operable, if the determination unit determines that the external device is valid, to generate verification data from target data with use of the key dependent function for secretly communicating the target data, the verification data being for verifying validity of the target data.
